(19) United States
(12) Patent Application Publication
(10) Pub. No.: US 2014/0040826 A1
(43) Pub. Date: Feb. 6, 2014

(54) METHOD FOR OPERATING SCREEN AND ELECTRONIC DEVICE THEREOF

(71) Applicant: Samsung Electronics Co., Ltd., Gyeonggi-do (KR)

(72) Inventors: Xiao WEI, Beijing (CN); Zongxue WANG, Beijing (CN); Xitao ZHANG, Beijing (CN)

(73) Assignee: Samsung Electronics Co., Ltd., Gyeonggi-do (KR)

(21) Appl. No.: 13/955,471

(22) Filed: Jul. 31, 2013

(30) Foreign Application Priority Data
Aug. 1, 2012 (CN) 201210272556.7
Sep. 24, 2012 (CN) 201210358230.6

(51) Int. Cl. G06F 3/0488; G06F 3/0481

(52) U.S. Cl. CPC G06F 3/0488; G06F 3/04817
USPC 715/810

(57) ABSTRACT

A system supports quick selection and positioning of an application by detecting a touching operation in a predetermined region, mapping the detected touching operation to a corresponding region of the destination page, and selecting the icon of the application on the corresponding region. A screen operation device using the system, comprises a display module for displaying an operation interface, an input module for collecting user operation information and generating operation data, and a selection engine module.

### CLAIM OF PRIORITY

This application claims priorities under 35 U.S.C. §119(a) to Chinese Patent Applications filed in the State Intellectual Property Office of China on Aug. 1, 2012 and assigned Serial No. 201210272556.7 and on Sep. 24, 2012 and assigned Serial No. 201210358230.6, the contents of which are herein incorporated by reference.

### FIELD OF INVENTION

The present disclosure relates to the field of mobile device communication and an electronic device, and particularly relates to a method for performing quick positioning of an application and screen operation method, and the electronic device thereof.

### BACKGROUND

Microelectronic technology and computer software handle more and more complicated work and provide the possibility of achieving personalization of terminal equipment in the absence of a network. Users desire more complex functions, intelligence, mobility and multifunction capability. This desire is addressed by smart phones, PDA and tablet computers with large screens operated by touch and simplified keyboard or, input switches, for example. A terminal with a big screen meets the requirements of more applications but brings challenges. Searching for data and in applications and remembering key words for searching becomes more important.

It is difficult for a user to control a big screen with a single hand requiring a good deal of dexterity and operation of buttons separated by a distance rendering operation impossible.

EP 1956472A (corresponding to Chinese patent application No. 200810125875.9) discloses a method of moving icons or moving icons into folders on a display of a mobile device. When an icon to be moved has been selected, its appearance changes with respect to the other icons so as to provide a visual cue to the user about the movement, and when the icon is moved over another icon, the changed icon is overlapped on the other icon. If a current location is selected, a moving cursor which indicates where the icon is to be placed is used to display the icon. Adopting dialog boxes which are configured to be able to enable names and icons of folders to be chosen and/or selected also provides a method for creating new file folders on a display. Default names and folder icons can be used, and spare icons can be displayed in the dialog boxes to enable the preview of a selection. U.S. 2006/265727 (corresponding to Chinese patent application No. 200480018377.4) discloses a method of retrieving and display of an icon. After a user initiates display a service guide on a display, mobile device operation is initiated, and needed ESG data fields are retrieved from storage. The ESG data includes starting time and ending time of a service, and the system displays icons associated with individual services. Thus, an icon is displayed beside each service, and the icon indicates the service type such as movie, current event. Other icons relate to some service or service provider, and may have a different priority than the service type icons.

U.S. 2009/289903 (corresponding to Chinese Patent Application No. 200810301699.X) discloses a method of controlling touch screen icon display, which is applicable to a touch screen. The touch screen comprises an icon control area and an icon display area, each display grid being configured to display an icon, and the display grid comprises a selected location for displaying a selected icon. The method comprises steps of: initiating the touch screen to display a control area and a display area on the touch screen, and put a predetermined icon in a selected area; judging whether a touch action is detected in the control area; if it is detected, judging whether a moved distance is beyond a predetermined distance; if the moved distance is not beyond the predetermined distance, then rotating the icon by one display grid according to the sequence corresponding to the touch direction, and rotating an icon which is nearest to the selected location to the selected location; and if the moved distance is beyond the predetermined distance, then rotating the icon by two display grids according to the sequence, and rotating an icon which has a two-display grid distance to the selected location to the selected location. This method enables a user to choose a needed icon quickly, and provides convenience to the user.

These known user interface systems rely on use of fingers to select directly, or select by a one to one correspondence way, require relatively large area touch screens and lack flexibility in icon selection and manipulation. A system according to invention principles addresses these deficiencies and related problems.

### SUMMARY

A system according to invention principles enables use of multiple schemes to select program icons, support screen operation and control using one finger and a small screen control and to select and operate different icons or intervals in the screen. In response to user command, a small area selection mode is entered which reverts to an original icon selection method upon mode termination. The system provides quick positioning of applications and icons on an electronic device such as a portable terminal. The system facilitates selection and manipulation of applications of a destination page in a predetermined region.

A user interface method supports user entry of commands into an electronic device by detecting a touch in a predetermined region of a destination page comprising a window area of reduced size within the destination page facilitating single handed operation of the electronic device. The method maps the detected touch to a corresponding region of the destination page external to the predetermined region, and selects an icon of an application on the corresponding region in response to the detected touch of a corresponding icon within the predetermined region.

In a feature of the invention the method switches the destination page upon detecting that the predetermined region is touched in excess of a predetermined time, or clicking a button for switching the destination page on the predetermined region; determining that the current page is the destination page when it is detected that a long duration touch is terminated or clicking the button for switching the destination page is stopped. The predetermined region includes one or more areas of a blank area of the screen and a floating window suspended on the screen and has a mapping in one-to-one correspondence with the screen areas where applications are on the destination page, or a mapping in one-to-one correspondence with the screen areas where parts of the applications are on the destination page. The mapping of the predetermined region is transparent to a user or is displayed on the predetermined region, and the mapping displayed on the predetermined region comprises mapping the icon of the application on the screen area displayed on the corresponding position of the predetermined region. The method further executes the selected application when the icon of the application on the corresponding area is selected and the touching action is stopped on the predetermined region.

In an inventive feature, an electronic device user interface system supports user entry of commands into an electronic device using a detection module configured to detect a touching operation in a predetermined region of a destination page comprising a window area of reduced size within the destination page facilitating single handed operation of the electronic device. A mapping module is configured to, map the detected touching operation to a corresponding region of the destination page external to the predetermined region, and select an icon of an application on the corresponding region in response to the detected touch of a corresponding icon within the predetermined region.

In a further feature of the invention the mapping module is used to map screen areas presenting icons associated with applications on the destination page in one-to-one correspondence with the predetermined region, or map screen areas associated with portions of the applications on the destination page in one-to-one correspondence with the predetermined region and the mapping of the predetermined region is transparent to a user or is displayed on the predetermined region. An execution module runs a selected application when the detection module detects that the icon of the selected application on the corresponding area is selected and the touching action on the predetermined area is stopped.

A further inventive method generates an operation interface screen including a small inner-screen region where corresponding candidate objects are presented. The method provides a big inner-screen region in an area on the operation interface not covered by the small inner-screen region, and arranging the candidate objects that can be operated by the operation objects in the big inner-screen region. The method involves configuring operation of the candidate objects in the big inner-screen region by assigning operation actions on the operation objects in the small inner-screen region. The candidate objects and the operation objects respectively comprise at least one object of, icon, interval, region, block, content, text, and image, wherein the operation actions comprise at least one action of, selection, translation, flip and rotation. The method also comprises completing an operation of searching, selecting or controlling a candidate object in the big inner-screen region by imposing the operation actions on the operation objects in the small inner-screen region.

In a further feature the method comprises (a) selecting an area that has been separated in the small inner-screen region; (b) after the selection, the screen entering into the corresponding selected area and completing rearrangement of the candidate objects in the selected area; if a candidate object that needs to be selected has been separated into a candidate area separately located within the small inner-screen region, selecting the candidate object directly; otherwise, repeating steps (a) and (b). The method comprises exiting a current small inner-screen region by selecting a back, cancel or shift operation wherein the back, cancel or shift operation is chosen by an operation mode of a key press, drawing with a pen and dragging to the small inner-screen region. Also the rearrangement comprises: rearranging the candidate objects in the big inner-screen region separately; or placing the candidate objects around the small inner-screen region as a circular arrangement.

In addition the method comprises when an operation mode needs to change, restoring an original operation or changing to a new operation mode by closing or switching the small inner-screen region wherein the small inner-screen region is a fixed area or an unfixed area, wherein the size of the small inner-screen region is a fixed value or an adjustable value, wherein the location of the small inner-screen region is fixed or movable, wherein the candidate objects in the big inner-screen region are changed in an identical or un-identical way with the operation objects in the small inner-screen region, wherein the screen comprises any of the following functions, supporting translation and rotation of the full screen, supporting translation, rotation and zooming of a portion of the screen, wherein the screen supports column operation, row operation or indefinite operation on icons, and wherein the operation of the candidate objects is performed by alternatively using the small inner-screen region and the big inner-screen region.

In another feature an electronic device comprises a display module, configured to display an operation interface, wherein the operation interface contains at least one candidate object; an input module, configured to collect operation information and generate operation data, which comprises: a first module configured to make a small inner-screen region contained in the operation interface and make operation objects corresponding to candidate objects presented in the small inner-screen region; and a second module configured to provide a big inner-screen region in an area of the operation interface external to the small inner-screen region, and arrange the candidate objects that can be operated by the operation objects in the big inner-screen region; and a selection engine module configured to process operation data sent by the input module so as to complete operation of the candidate objects in the big inner-screen region by imposing operation actions on the operation objects in the small inner-screen region.

### BRIEF DESCRIPTION OF DRAWINGS

The above and/or additional aspects and advantages of the present invention will be obvious and easy to understand from the following depictions of embodiments in combination with the accompanying drawings, wherein:

FIG. 1 is a flow chart showing the method for quickly positioning an application in the embodiments of the present invention;

FIG. 2 is a schematic diagram showing that the predetermined region is a blank area on the screen;

FIG. 3 is a schematic diagram showing that the predetermined region is a floating window suspended on the screen;

FIG. 4 is a schematic diagram showing that the predetermined region is a floating window with marks;

FIG. 5 is a schematic diagram showing that the screen is automatically scrolled by a long duration touch in the blank area thereof;

FIG. 6 is a schematic diagram showing that the screen is automatically scrolled by a long duration touch on the floating window;

FIG. 7 is a schematic diagram showing that a destination page is switched by clicking;

FIG. 8 is a schematic diagram showing clicking a button to switch a destination page;

FIG. 9 is a schematic diagram showing that an APP is precisely positioned on the floating window with marks of applications;

FIG. 10 is a schematic diagram showing that an incorrect operation is corrected;

FIG. 11 is a schematic diagram showing that the predetermined region is a blank floating window;

FIG. 12 is a schematic diagram showing the structure of terminal equipment in the embodiments of the present invention.

FIG. 13 is a structural diagram according to an exemplary implementation of the present invention;

FIG. 14 is a structural diagram according to another exemplary implementation of the present invention;

FIG. 15 is a schematic diagram of an interface according to another exemplary implementation of the present invention;

FIG. 16 is a schematic diagram of an interface according to another exemplary implementation of the present invention;

FIG. 17 is a schematic diagram of an interface according to another exemplary implementation of the present invention;

FIG. 18 is a schematic diagram of an interface according to another exemplary implementation of the present invention;

FIG. 19 is a schematic diagram of an interface according to another exemplary implementation of the present invention;

FIG. 20 is a schematic diagram of an interface according to another exemplary implementation of the present invention;

FIG. 21 is a schematic diagram of an interface according to another exemplary implementation of the present invention;

FIG. 22 is a schematic diagram of an interface according to another exemplary implementation of the present invention;

FIG. 23 is a schematic diagram of an interface according to another exemplary implementation of the present invention;

FIG. 24 is a schematic diagram of an interface according to another exemplary implementation of the present invention;

FIG. 25 is a schematic diagram of an interface according to another exemplary implementation of the present invention;

FIG. 26 is a schematic diagram of an interface according to another exemplary implementation of the present invention;

FIG. 27 is a schematic diagram of an interface according to another exemplary implementation of the present invention;

FIG. 28 is a flowchart according to another exemplary implementation of the present invention;

FIG. 29 is a schematic diagram of an interface according to another exemplary implementation of the present invention;

FIG. 30 is a schematic diagram of an interface according to another exemplary implementation of the present invention;

FIG. 31 is a flowchart according to another exemplary implementation of the present invention;

FIG. 32 is a flowchart according to another exemplary implementation of the present invention;

FIG. 33 is a flowchart according to another exemplary implementation of the present invention;

FIG. 34 is a schematic diagram of an interface according to another exemplary implementation of the present invention; and

FIG. 35 is a schematic diagram of an interface according to another exemplary implementation of the present invention.

### DETAILED DESCRIPTION

Exemplary implementations of the invention will now be described with reference to the accompanying drawings. However, the present invention may be implemented in many different forms and should not be construed as limited to the specific embodiment set forth herein; rather, these implementations are provided in order to make this invention disclosure be thorough and complete and to fully convey the inventive thoughts, concepts, purposes, ideas, reference schemes and the scope of protection to those skilled in the art. The terminologies used in the detailed description of the specific exemplary embodiment illustrated by the accompanying drawings are not intended to limit the current invention. Like numbers refer to like elements throughout the accompany drawings.

It will be understood by the skilled in the art that the singular forms “a”, “an”, “the”, and “said” may be intended to include plural forms as well, unless the context clearly indicates otherwise. It should be further understood that the terms “comprises/comprising” used in this specification specify the presence of stated features, integers, steps, operations, elements, and/or components, but do not preclude the presence or addition of one or more other features, integers, steps, operations, elements, components, and/or groups thereof. It should be understood that when a component is referred to as being “connected to” or “coupled to” another component, it can be directly connected or coupled to the other element or intervening elements may be present. In addition, the “connected to” or “coupled to” may also refer to wireless connection or couple. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The “terminal equipment” used here comprises not only equipment that only possesses a wireless signal receiver without transmission ability but also equipment that possesses receiving and transmission hardware capable of performing bidirectional communication in a bidirectional communication link. The equipment may comprise: cells or other communication equipment with or without multi-line display; a personal communication system (PCS) that may combine audio and data processing, fax and/or data communication ability; a personal digital assistant (PDA) that may comprise a radio receiver and pager, internet/intranet access, web browser, Notes, calendar and/or global positioning system (GPS); and/or a conventional laptop and/or palmtop computer or other equipment comprising a radio receiver. The “terminal equipment” used here may be portable, transportable, or may be mounted on the vehicle (aviation, ocean shipping and/or land), or may be adapted to and/or configured to run locally and/or to run in a distributed form at any other position of earth and/or space.

Those skilled in the art will understand that the term “terminal” or “portable terminal” used herein compasses not only devices with a wireless signal receiver having no emission capability but also devices with receiving and emitting hardware capable of carrying out bidirectional communication over the two-way communication link. This kind of devices may include a cellular or other communication device with or without a multi-line display; a personal communication system (PCS) with combined functionalities of voice and data processing, facsimile and/or data communication capability; may include a PDA having a RF receiver and an internet/intranet access, web browser, notepad, calendar and/or global positioning system (GPS) receiver; and/or a conventional laptop and/or palm computer or other devices having a RF receiver. The “mobile terminal” used herein may refer to portable, transportable, fixed on a transportation (aviation, maritime and/or terrestrial) or suitable for and/or configured to run locally and/or run in the form of distribution on the earth and/or other places in the spaces. The “mobile terminal” used herein may also refer to a communication terminal, Internet terminal, music/video player terminal. The “mobile terminal” used herein may also refer to PDA, MID, and/or mobile phone with music/video playback capabilities etc. The “mobile terminal” as used herein may also be a smart TV, set-top box etc.

Those skilled in the art will understand that the detailed implementations of the invention are illustrated by using exemplary portable multi-functional devices with a touch screen display. However, those skilled in the art should understand that some user interfaces and associated processing method thereof can be applicable to other devices such as a device including one or more physical user interface such as physical click keys, physical track wheel, and physical touch-sensitive area of a desktop computer or a notebook computer.

A system supports quickly positioning an application, detects a touching operation in a predetermined screen region, maps the detected touching operation to a corresponding region of a destination page, and selects an icon of an application on the corresponding regions.

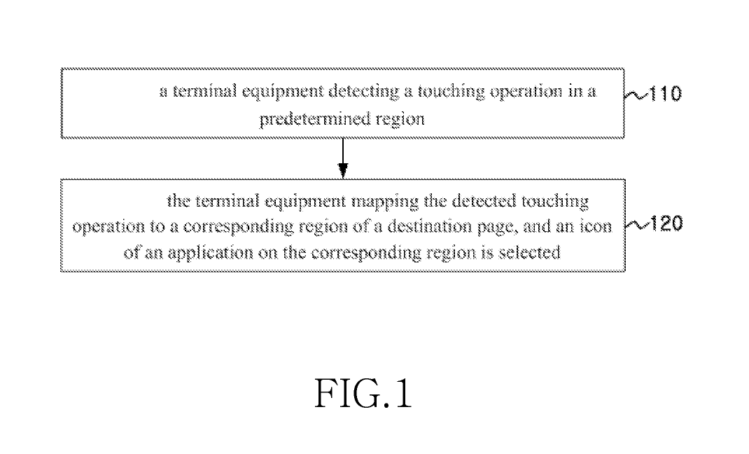

FIG. 1 shows a flow chart showing the method for quickly positioning an application in one embodiment of the present invention. In step S110 a terminal detects a touching operation in a predetermined region. The system addresses the difficulty of precisely positioning a destination APP (e.g. executable application window) after entering accessing a user interface for selecting an application. The system supports positioning and selecting a destination APP in a predetermined region including the following areas: a blank area of the screen and/or a floating window suspended on the screen.

Further, before the terminal detects a touching operation in a predetermined region, the terminal identifies the predetermined region. For instance, if it is detected that the user touches the main screen, a blank area or a floating window is presented, wherein the operation for presenting the predetermined region may be preset, for instance, presenting the predetermined region by a touching operation comprising a long duration touch or clicking a start key, or by a long duration touch on a blank area of the screen. In particular, when the presented predetermined region is a blank area, the blank area is displayed at a fixed position; when the presented predetermined region is a floating window, the floating window is displayed on an arbitrary position of the screen since the floating window may be dragged by a user, and preferably the floating window is displayed on the screen area where the user's finger is, so as to facilitate user operation.

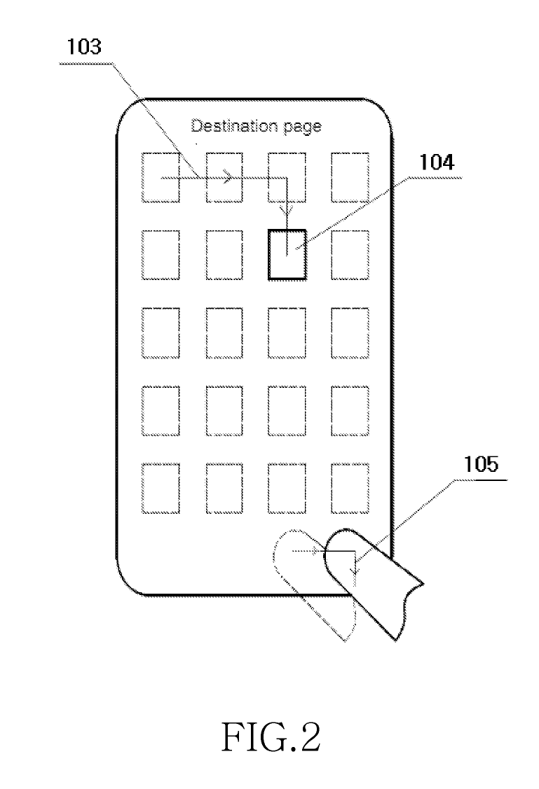

FIG. 2 shows a schematic diagram indicating that the predetermined region is a blank area on the screen. As shown in 105 of FIG. 2, the starting point of drawing a line by finger serves as the initial position of the predetermined region, for instance, it is configured as a square with a size of 1 cm*1 cm, or the predetermined region proportional to the size of the screen.

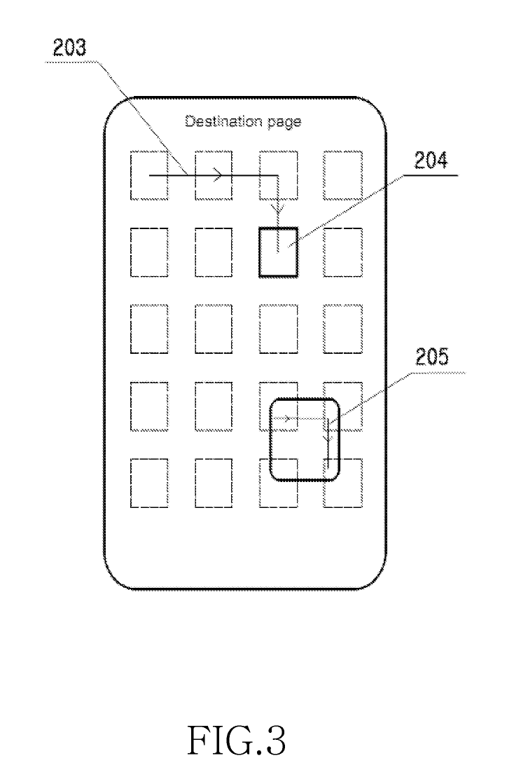

FIG. 3 presents a schematic diagram showing that the predetermined region is a floating window suspended on the screen. As shown in 205 of FIG. 3, the starting point of drawing a line by finger serves as the initial position of the predetermined region, for instance, it is configured as a square with a size of 1 cm*1 cm, or the predetermined region is proportional to the size of the screen.

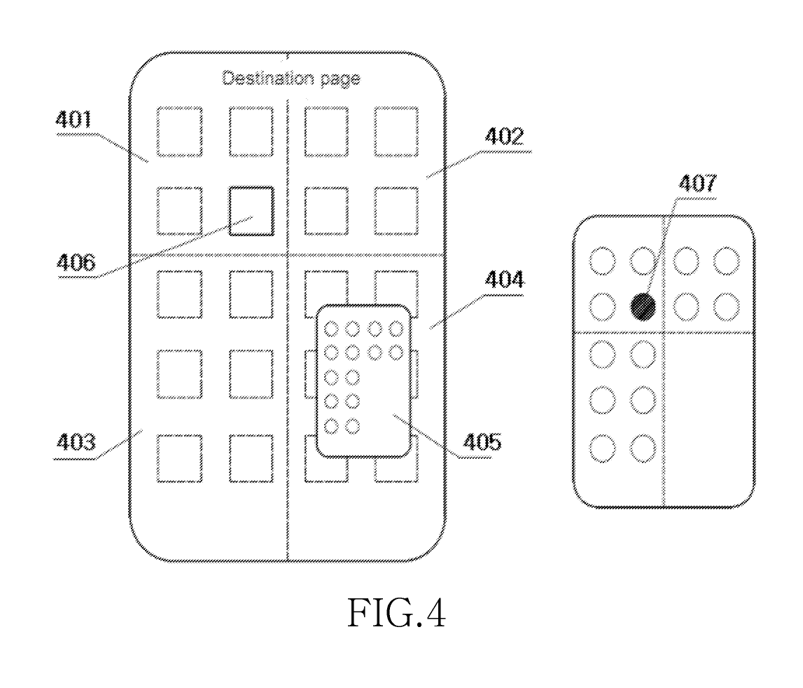

FIG. 4 presents a schematic diagram showing that the predetermined region is a floating window with marks. The floating window is, for example, area 405 in the figure, which may be located at any position of the screen, such as any of area 401, 402, 403 or 404 in FIG. 4.

A destination page may be switched according to user selection, for instance, the destination page is switched as the terminal equipment detects that the predetermined region is touched for a long duration (in excess of a predetermined threshold), or the button for switching a destination page on the predetermined region is clicked; and the current page is determined to be a destination page in response to detection of termination of a long duration touch or clicking a button for switching a destination page ends.

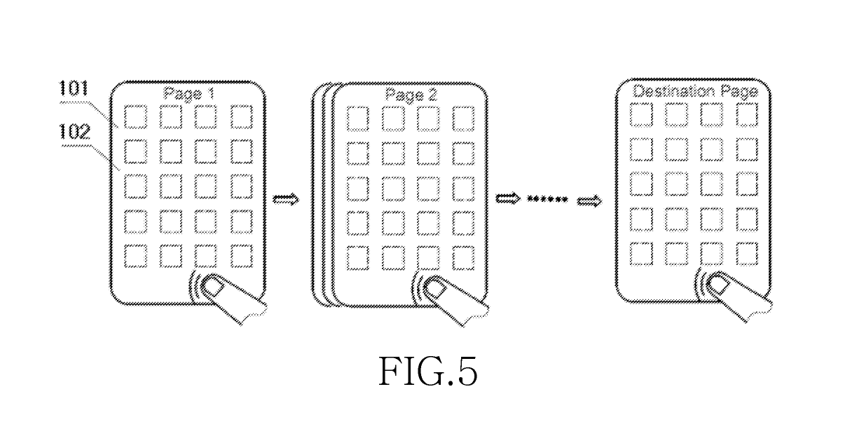

Illustrating switching a destination page, FIG. 5 shows a screen is automatically scrolled by a long duration touch in a blank area, wherein 101 refers to the screen itself, and 102 refers to an APP (i.e. application) on the screen. The blank area on the screen is configured to monitor a long duration touch action of a user finger. In response to system detection of the user's finger performing a long duration touch on the blank area on the screen, the screen is configured to be traversed from front to back or from back to front, to achieve automatic scrolling of the screen. The user may configure the specific scrolling action, for instance, the time interval of the automatic traverse and switch process between screens. A default setting comprises 2 seconds, for instance, and may be configured to be longer. When it is found that a desired APP is on the current screen, the action of a long duration touch by finger is canceled. The screen detects that the action of a long duration touch is canceled, and the screen is no longer automatically scrolled, i.e. it stops on the current screen so that the screen where the APP is required is selected and positioned.

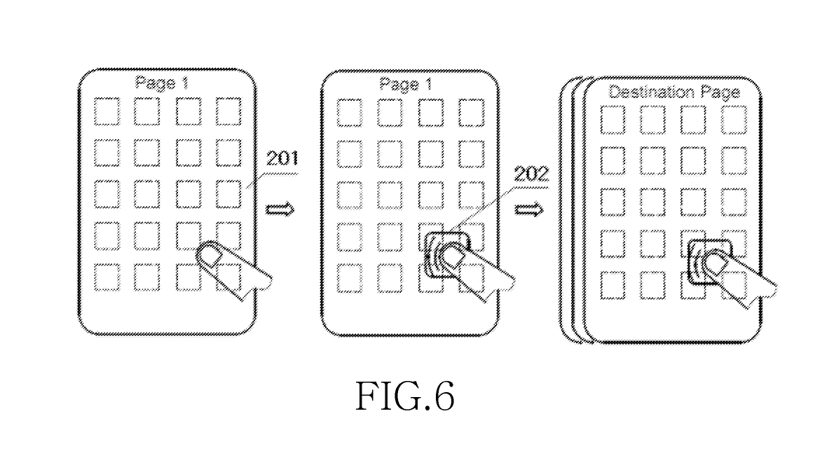

As another embodiment of switching a destination page, FIG. 6 shows a schematic diagram presenting a screen automatically scrolling in response to a long duration touch on a floating window. With respect to a screen with a smaller blank area, a transparent floating window is presented by touching the screen, and the screen is automatically scrolled by a long duration touch on the floating window, thereby positioning the destination screen of an APP. The screen is configured to monitor the action of touching the screen with a finger without selecting a particular APP, and may be interpreted as an action of touching a smaller blank area. When the a user's finger touches the screen and, i.e. after the screen detects the action of touching the screen by finger, transparent floating window 202 is presented, which may be controlled by the user to by zoom in and zoom out operations and may move freely, i.e. the floating window moves to the a place where the a finger moves to. The floating window is controlled according to user historical use and habit, such when the terminal is held by a single hand, a finger does not need to move back and forth over a large screen expanse, and the floating window controls automatic scrolling without need for changing a handholding gesture. The floating window is configured to monitor the action of a long duration touch and the floating window detects the action of a long duration touch and initiates screen traverse from front to back (or from back to front, which may be configured by the user), thereby achieving automatic scrolling. When it is found that a desired APP is present on the a current screen, the action of a long duration touch by finger is canceled, and at that time the floating window may detects that the action of by finger has been canceled an the screen is no longer automatically scrolled so that scrolling stops at the current screen with the desired APP.

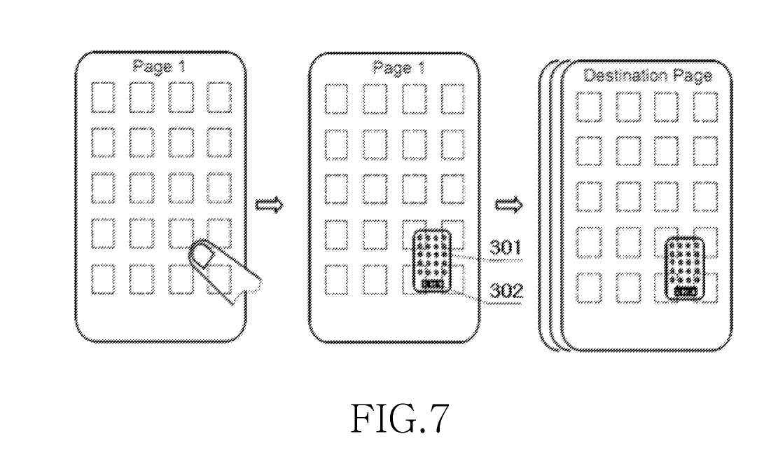

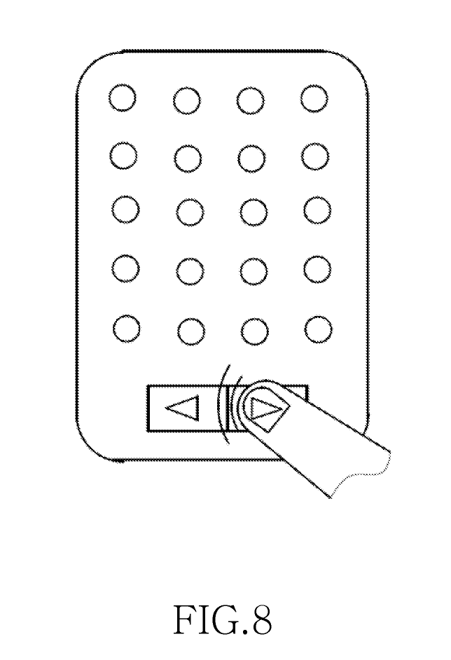

Further, illustrating switching a destination page, FIG. 7 presents a schematic diagram showing that a destination page is switched by clicking and FIG. 8 is a schematic diagram showing clicking a button to switch a destination page. The system is configured to monitor the action of a long duration touch of a scrolling button of the floating window and initiates screen traverse from front to back to achieve automatic scrolling; for example, when selecting the backward scrolling button, the screen automatically scrolls from back to front. In response to detection of a desired APP on a current screen, the action of a long duration finger touch and automatic scrolling is canceled.

In step S120 (FIG. 1), the terminal maps a detected touching operation to a corresponding region of a destination page, and the icon of the application on the corresponding region is selected. A predetermined region is associated in one-to-one mapping correspondence with the screen areas where applications are located on a respective destination page. Alternatively, a predetermined region is associated in one-to-one correspondence mapping with screen areas where parts of applications are located on a respective destination page.

Specifically, when a predetermined region is mapped in one-to-one correspondence with the screen areas where applications are located on a destination page, the respective subareas of the predetermined region are mapped with each screen area displaying an application icon on the destination page. Further when a destination area is mapped in one-to-one correspondence with the screen areas where parts of applications are on the destination page, the respective subareas of the predetermined region are mapped with parts of the screen areas displaying application icons on the destination page. The mapping relation may be static, that is, the fixed area on the predetermined region is mapped to the fixed area on the destination page. The mapping relation may also be dynamic so that a user initial touching point on a predetermined region is mapped to the fixed area on the destination page, thereby dynamically mapping other screen areas according to a sliding track of a use touching path. For instance, when a user initial touching point slides upward, the fixed area mapped by the initial touching point serves as the starting point on a destination page, and the sliding track moves upward.

Specifically, the above described mapping of the predetermined region occurs transparently and seamlessly and maybe displayed on the predetermined region, to expedite application selection. the mapping displayed on the predetermined region comprises a mapping presenting an icon representing the application on the screen area displayed in a corresponding position of the predetermined region, for example, as illustrated by the predetermined region 405 in FIG. 4, representing the destination page wherein each circle of region 405 maps to and enables selection of, a corresponding application upon circle selection.

For example, as illustrated in FIG. 2, when the predetermined region is a blank area on the destination page, wherein the blank area has marks in one-to-one correspondence with the applications on the destination page (marks are not shown in the figure, and there is no necessity of using a mark prompt, positional mapping achieves the purpose). When the blank area is mapped to parts of the applications on the destination page in one-to-one correspondence, applications corresponding to a distal end of the destination page are marked, such as the upper three lines, but does not the applications of the lower two lines. The applications of the lower two lines are manipulated by touch and do not need mapping. If mapping is desired, a corresponding application is launched by direct button clicking and mapping is user configurable

When the predetermined region may be in one-to-one correspondence with the screen areas where parts of the applications are on the destination page, parts of the applications are applications on the screen area outside a first area, wherein where the first area is 1/N area of the screen of the destination page and, N is greater than or equals to 2. For instance, in FIG. 4, 404 the first area, is the area where encompasses the predetermined region 405. The 404 precisely is a first area. Since the user's finger can touch the area 404 and, there is no need of mapping this area, but the system maps areas other than the area 404, such as area 401, area 402, and area 403. A first area refers to an area where the predetermined region is located, that is, in FIG. 4, if the predetermined region 405 moves to the area 403, the area 403 is the first area.

A user may directly operate the first area, i.e., when the first area is touched, the icon of the application corresponding to the touch on the first area is selected. Thus, a user can select an application displayed on the first area without the aid of the predetermined region. According to an embodiment of the present invention, the floating window may be dragged. When the floating window is dragged to a second area, the floating window and is mapped in one-to-one correspondence with the screen areas where the applications are located on the screen area outside the second area, wherein the second area is 1/N area of the screen of the destination page. A terminal maps a detected touching operation to a corresponding region of a destination page and an icon of the application on the corresponding region is selected. Specifically, when it is detected that the predetermined region is touched, the icon of the application on the default position of the destination page is selected. Also when it is detected that the touching point is sliding on the predetermined region, the sliding track of the touching point is mapped on the destination page with the default position of the destination page as the starting point, and when the sliding track goes intersects the icon of an application, the icon of the application is selected.

A default position is determined according to the mapping between the predetermined region and the area on the destination page. For instance, in the case that a user maps the initial touching point of the predetermined region to a fixed area on the destination page, the default position is a fixed position on the destination page. That is, irrespective of where the user touches the predetermined region, the fixed application on the destination page is selected. Alternatively, when the fixed area on the predetermined region is mapped to the fixed area on the destination page, the default position is an area determined according to the mapping relation. For instance, the predetermined area is enlarged to be the screen area where the mapped application is located and the touching point position corresponds to the screen area where the mapped application is. A shape of the area with a preset size and the shape of a destination page may comprise similar polygons. When a sliding track intersects an icon of an application, the icon of the application is selected. When the sliding track intersects an icon of a next application, the former passed application returns to the state of not being selected. As an icon of an application is selected, the state of being selected is highlighted on the screen.

FIG. 2 is a schematic diagram showing precise positioning an APP on a blank area. The finger starts an action of drawing a line on a blank area of the screen, as shown in 105 of FIG. 2. The line drawn area of the blank area is configured to map the coordinate of the respective APPs on the screen, and the lines drawn by a finger are mapped to APPs on the screen, so the line drawn area is proportional to the size of the screen and there are many routes to a designated APP. The movement running track of the corresponding line is displayed on the screen, and the running track is displayed with solid lines or dotted lines in response predetermined configuration data. As shown in 103, the running track is displayed on the screen to APP 104 requiring positioning. After the screen detects that the action of drawing a line has been completed the APP is selected achieving precise positioning.

When the predetermined region is a floating window, the floating window includes a blank floating window, or a floating window having marks in one-to-one correspondence with applications on the destination page. FIG. 3 is a schematic diagram showing precisely positioning of an APP on the floating window (taking the blank floating window as an example, and the case of the floating window with marks is the same as this case). The terminal equipment mapping maps the detected touching operation to a corresponding region of the destination page comprises the following steps: by, when it is detected that the blank floating window is touched, the system selects an icon of the application on at the default position of the destination page, is selected; when it is detected that the a user finger slides on the blank floating window, the system maps a sliding track of the touching point is mapped to the destination page with the default position of the destination page as the starting point; and when the sliding track intersects an the icon of an application, the icon of the application is selected. The shape of the blank floating window and the shape of the destination page are similar polygons in an embodiment. The default position is a fixed position or a corresponding position of the touching point on the destination page when the blank floating window is enlarged to be a destination page. For instance, a default position is precisely mapped to a central position of the destination page by touching the central position of the floating window.

A floating window also monitors the action of creating finger drawn lines in addition to a long duration touch action. When the screen where an APP is to be selected is shown, a finger drawn line on the floating window, as shown in 205 of FIG. 3, is mapped to the coordinates of the respective APPs on the screen, and the line drawn area is proportional to the size of the screen. The movement track of the corresponding line is displayed on the screen in solid or dotted lines as illustrated in 203. When the system detects drawn lines in a floating window a user is able to directly enter the APP achieving precise positioning.

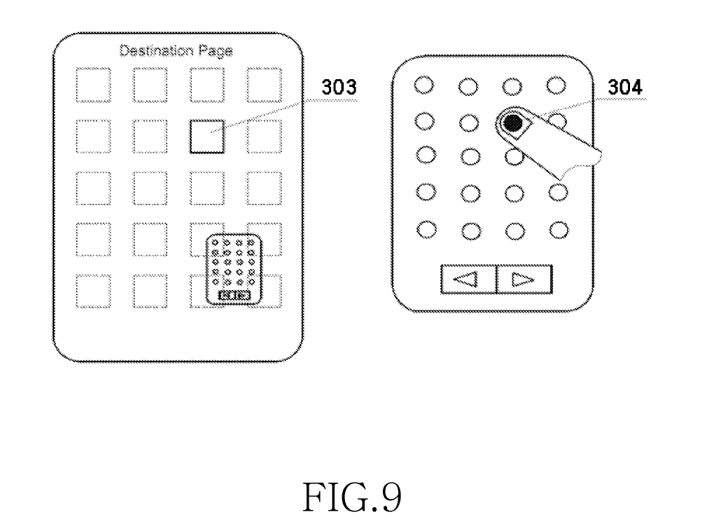

FIG. 9 is a schematic diagram showing precisely positioning an APP on a floating window having marks representing applications. For instance, precise positioning of an APP is achieved by selecting a small black circle on the floating window of the destination screen. The floating window displays a small black circle mapped to an APP on the current screen in addition to a scrolling button. In order to facilitate user selection, the arrangement of the small black circles is consistent with the arrangement of APPs on the screen, and the coordinate of APPs on the screen is mapped to the small black circles on the floating window in one-to-one correspondence. That is, the small black circles on the floating window are mapped in one-to-one correspondence with APPs on the screen, wherein the small black circles on the floating window are used to monitor the selection of user's finger. In response to identifying a position on a screen where an APP is required to be selected, a user selects a certain small black circle on the floating window. As shown in 304 of FIG. 9, APP 303 on the corresponding screen indicates this APP is selected by highlight or animation, and the selection is completed by detection of withdrawal of the finger and initiation of the APP achieving precise positioning.

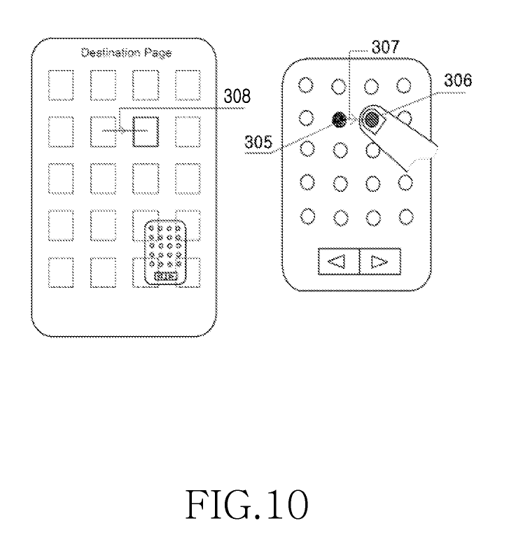

In addition, when there is an incorrect operation, the system re-positions an APP by drawing lines using a small black circle. As illustrated in FIG. 10, showing correcting an incorrect operation to position the highlighted APP on the screen in FIG. 9, due to inadvertent selection of small black circle 305 resulting in incorrectly initiating a different APP. In order to avoid such an error, when the small black circle 305 is selected and an incorrect operation occurs, a user does not withdraw a finger but re-positions selection by drawing a line to the right 307 to the small black circle 306, and the running track displayed on the corresponding screen as 308. The corresponding APP is indicated by highlight or animation and the corrected re-positioning is achieved by withdrawal of the finger.

The system prior to detection of a touching operation on the predetermined region, detects a touching operation on the first area, directly selecting the icon of the application on the first area, or presenting the floating window suspended on the first area, wherein the first area is 1/N area of the screen of the destination page and N is greater than or equal to 2. As illustrated in FIG. 4, the first area of the screen of the destination page is any of area 401, 402, 403 or 404 in FIG. 4. In addition, the predetermined region further comprises predetermined region 405, wherein the predetermined region 405 is a floating window suspended on the destination page.

The terminal (system) detects a touching operation on the first area, directly selecting the icon of the application on the first area, or presenting the floating window suspended on the first area. The floating window includes a blank floating window, or a floating window having marks in one-to-one correspondence with other applications on the destination page other than the first area.

When the predetermined region is a blank floating window, the terminal equipment mapping a detected touching operation to a corresponding area of the destination page. Specifically, when it is detected that the blank floating window is touched, the icon of the application on the default position of the destination page is selected,; when it is detected that the user finger slides on the blank floating window, the sliding track of the touching point is mapped to the destination page with the default position of the destination page as the starting point, and when the sliding track intersects an icon of an application, the icon of the application is selected.

The shape of the blank floating window and the shape of the destination page are similar polygons. The default position is a fixed position or a corresponding position of the touching point on the destination page when the blank floating window is enlarged to be a destination page. For instance, the default position is precisely mapped to a central position of the destination page by touching the central position of the floating window. Specifically, the screen user interface areas that the user's finger is accustomed a user to is able to operate are different with respect to different manners of handholding equipment by the user differ in response to how a device is held. When a single hand operates equipment, especially equipment with a bigger screen, the user's finger generally can only typically conveniently operate one a limited area. The user can directly select APP on the screen areas where the user's finger can conveniently operate. If a user wants to select an APP far from the areas that the finger is accustomed to operate, it is very inconvenient.

A screen is divided into a plurality of areas, for example, four areas, as illustrated in FIG. 4, so it is possible to address different methods of handholding a terminal. Irrespective of an area the user is accustomed to operate, area 401 or 402 or 403 or 404, the system works if a user is able to operate virtually any screen area to achieve precise positioning of APPs on the screen and perform other functions.

Taking the user's finger operation area 404 as an example, the user can directly select APPs within the area 404. Areas 401, 402 or 403 other than area 404, are far from the user's finger and are difficult to operate. The system enables to initiate presentation of the floating window by a long duration touch or by touching area 404 as shown in 405. the APPs of other areas 401, 402 and 403 are out of reach of a finger are mapped to the floating window and displayed correspondingly in the small black circle. The mapping of small black circles displayed on the floating window of area 401, 402 or 403 is determined by estimating the finger operation area in response to predetermined information and according to the coordinates, achieving correct mapping of small black circles on the floating window to APP of area 401, 402 or 403. Thereby, selection of the mapped small black circles on the floating window provides selection of an APP on area 401, 402 or 403. If it is desired to select APP 406 on the screen, it is achieved by selecting a small black circle 407 on the floating window, such that precise positioning of all APPs on the screen is achieved in operating area 404.

Likewise, the system enables operation of area 401 to achieve precise positioning of APPs on the screen, and APPs within area 401 can be directly selected. With respect to area 402, 403 or 404 other than area 401, the presented floating windows may map APPs on area 402, 403 or 404 by a long duration touch or touching the blank area of area 401. The APPs on area 402, 403 or 404 can be positioned by selecting on the floating window, thereby achieving precise positioning of APPs on the screen using operating area 401. Similarly, precise positioning APPs on the screen can also be achieved by operating area 402 or area 403.

When different screen areas are operated, the mapping of an APP displayed on the floating window is different. Thus, when a user finger operates a particular area, directly selecting APPs within the area and selecting APPs outside the area is advantageously performed by selecting small black circles mapped to the floating window that is within easy finger reach of a terminal held by one hand. The According to an embodiment of the present invention, the floating window suspended can may be dragged, and when the floating window is dragged to a second area, the floating window has is dynamically re-configured with marks (icons) in one-to-one correspondence with other applications of the destination page other than those of the second area. The floating window can move with the movement of finger and when the floating window moves from area 404 to, for example, 401, the mapping on the floating window changes from the mapping of area 401, 402 or 403 to the mapping of area 402, 403 or 404, so that it is more convenient for the user to operate.

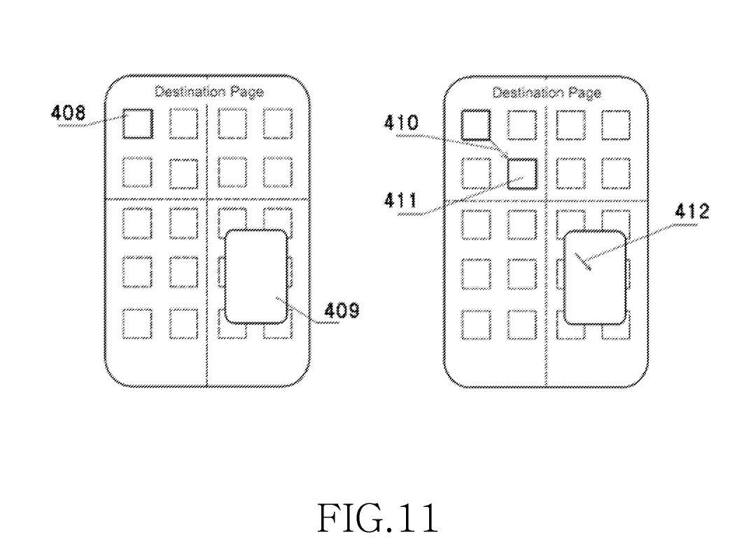

The floating window can be configured to be transparent except that the floating window displays small black circles of the mapped APPs. As illustrated in FIG. 11, showing that the predetermined region is a blank floating window. As 409 in FIG. 11, it is possible to directly select APPs within the areas convenient to be operated, and it is possible to initiate presentation of the transparent floating window by a long duration touch or touching the blank area when it is inconvenient to select APPs outside the areas, wherein the transparent floating window maps APPs outside the areas and in response user drawn lines. When the action of drawing lines is over, i.e. when the finger is withdrawn, APPs outside the areas on the corresponding screen are highlighted and the APPs are selected for positioning. When the transparent floating window is presented, for example, the first APP of the diagonal of the operation area is configured by defaulted as a focus APP. A user clicking the transparent floating window initiates operation of the highlighted APP. As illustrated in FIG. 11, APP 408 is the default focus APP and is displayed in highlight. If it is desired to select APP 408, it is possible to enter the APP by directly clicking the transparent floating window. If it is desired to select another APP, it is possible to enter this APP by withdrawal of the finger.

If it is desired to select APP 411, a user draws lines, such as 412, on the floating window, and the line drawn track of 412 is mapped to a corresponding line 410 on the screen. APP 411 is selected by withdrawal of the finger at end of track 412. Similar precise positioning of other APP related selection functions is achieved by drawing lines. Thus, the precise positioning of APPs on the screen is achieved by operating one limited single handheld accessible area. A terminal initiates operation of the selected application in response. According to an embodiment of the present invention, it also comprises: when the icon of the application on the corresponding area is being selected and the touching action ended.

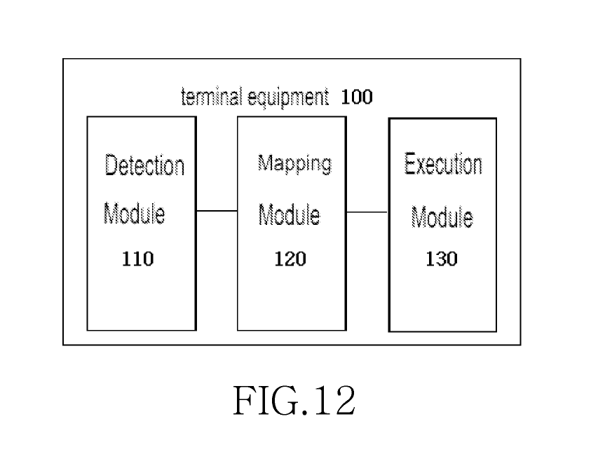

A user does not need to change the manner of handholding equipment and the finger may move within the range of the small area, so the operation is natural, convenient and comfortable. As illustrated in FIG. 12, terminal equipment 100, comprising a detection module 110, and a mapping module 120 and execution module 130. The detection module 110 is used to detect a touching operation in a predetermined region; and the mapping module 120 is used to map the detected touching operation to a corresponding region of the destination page, and the icon of the application on the corresponding region is selected. The detection module 110 is used to detect a touching operation on the blank area of the screen and/or on the floating window suspended on the screen.

When the detection module 110 detects that the predetermined region is touched for a long duration, or the button for switching a destination page on the predetermined region is clicked, the mapping module 120 is used to switch the destination page; when the detection module 110 detects that the long press is terminated or clicking the button for switching a destination page is stopped, the mapping module 120 maps the former page to the destination page. The detection module 110 is also used to detect the operation for presenting the predetermined region before detecting a touching operation in the predetermined region, and the mapping module 120 is also used to initiate presentation of the predetermined region after the detection module detects the operation of presenting the predetermined region.

The mapping module 120 is also used to map the screen areas where applications are on the destination page to provide one-to-one correspondence with the predetermined region, or map the screen areas where parts of applications are on the destination page in one-to-one correspondence with the predetermined region. The mapping of the predetermined region occurs transparently and seamlessly to the user, or may be displayed on the predetermined region. Furthermore, the mapping module 120 is also used to display mapping marks (icons) of applications on the screen area at corresponding positions of the predetermined region. When the mapping module 120 is used to map the screen areas where parts of the applications are on the destination page in one-to-one correspondence with the predetermined region, parts of the applications are applications on the screen area outside a first area. Further, the first area is 1/N area of the screen of the destination page and N is greater than or equal to 2. When the predetermined region is presented, it is displayed on the first area.

Furthermore, when the detection module 110 is used to detect that the first area is touched, the mapping module 120 is used to select the icon of the application corresponding to the touch on the first area. The floating window may be dragged to a second area and the mapping module 120 is used to map the screen areas including screen areas outside the second area, to the floating window, wherein the second area is 1/N area of the screen of the destination page. When the detection module 110 detects that the predetermined region is touched, the mapping module 120 is used to select the icon of the application at a default position of the destination page. When the detection module 110 detects that a touching point is sliding on the predetermined region, the mapping module 120 is used to map the sliding track of the touching point to the destination page with the default position of the destination page as the starting point. When the sliding track intersects an icon of an application, the icon of the application is selected. The default position mapped by the mapping module 120 may be a fixed position, or may be a corresponding position where the mapping module 120 maps the touching point to the screen area by where the mapped application is when the enlarging the predetermined region is enlarged to be the screen area. When the detection module 110 detects that the icon of the application on the corresponding area is selected and the touching action on the predetermined area is stopped, the execution module 130 is used to run the selected application.

The above equipment according to the present invention may achieve precise positioning of APP by controlling the applications of the destination page in a predetermined region, wherein fingers of a user advantageously need just operate a small area on the screen and without two hands. In addition, users do not need to change the manner of handholding and fingers may move within a comfortable range comprising a small area.

A person having ordinary skill in the art may appreciate that all or part of steps involved in the above method of the embodiments may use a machine executable program. The program may be stored in a computer readable storage medium. The program includes steps of the methods described herein.

In addition, the respective functional units in the respective embodiments of the present invention may be integrated in one processing module, and may also exist as single physical units, and may also be integrated in one module by two or more units. The above integrated module may be in the form of hardware, and in the form of a software functional module. When the integrated module is carried out in the form of a software functional module and is sold or used as an independent product, it may also be stored in a computer readable storage medium such as a read-only storage, disk or disc.

Also, here, those skilled in the art may understand that at least some embodiments include one or more application programming interfaces (APIs) comprising user interfacing software interacting with software applications. The API(s) can coordinate the execution of applications, storage allocation, and system resources management. An API may also comprise a large service center to call the service center's various services (each service is a function) and help an application to achieve opening windows, depicting graphics and using peripheral devices. Various service calls or messages are transmitted via application programming interfaces between user interface software and software applications. Transmission of these function calls or messages can issue, initiate, invoke, or receive these function calls or messages. An exemplary API transmission function call is used for a device with a display area to realize scrolling, gestures and animation operations. An API may receive parameters disclosed or other combinations of parameters. In addition to the published APIs, other APIs can perform functions similar to those of the published APIs individually or in combination.

Those skilled in the art will understand that display area as mentioned refers to a kind of window. A window is such a display area: that it has no boundary and can be the entire display area or range of a display. In some embodiments, a display area may have at least one window and/or at least one view (e.g., web pages, text, or image content). A window may have at least one view. The disclosed methods, systems, and devices may be implemented as having display area(s), window(s) and/or view(s). In some embodiments, a display area has a plurality of views or windows. Each window can have multiple views including the main views (superviews) and sub-views (subviews). If it is to be determined that which widow, view, main view or sub-view is contacted by lifting, pressing, and dragging the mouse, API settings can be used in various kinds of modes for this kind of determination. In an embodiment, in “pass always” mode, mouse down, mouse lift and drag input are sent to the nearest sub-view. In another embodiment, in “intercept on drag” mode, when mouse lift or down input is sent to a sub-view, drag input is sent to the main view. In another embodiment, in an “intercept always” mode, all drag, mouse lift and press inputs are sent to a main view. A sub-view can be view software working as a subset of the user interface software.

In some embodiments, the device's display may receive a user input in the form of two or more points. Multi-touch device driver of a device receives the use input and pack events into an event objects. A window server receives an event object and determines whether the event object is a gesture event object. If a window server receives the event object and determines whether the event object is a gesture event object. If the window server determines a gesture event object has been received, user interface software sends or initiates a processing gesture call to a software application related to the view. The software application confirms a gesture event and passes the call of processing of the gesture to a user interface software library. The window server also correlates the gesture event with the view that has received the user input. The library transmits the gesture change call by responding to the gesture processing event so as to make a response.

Gesture API provides an interface between the application and the user software to handle gestures. Gestures can include scaling, rotation, or other changes of a view, window, or display. A mask may allow specific changes while disallowing other changes. Event data is entered into an application via a graphics architecture. These events are queried, decomposed (when necessary) or dispatched, and if these events are system-level events (e.g., the application should be suspended, the device orientation has changed, and so on), then they will be directed to applications having a class of user interface software instances. If these events are user input based hand event, these events will be directed to a window where they occurred. The window then directs the events to suitable control parts by calling the mouse and gesture method of the instance. The control parts which have received the mouse press or mouse input function will go on receiving all future calls until the hand is lifted. If a second hand is detected, then gesture methods or functions will be invoked. These functions may comprise start, change and stop of the gesture call. Future changed gestures will be sent to control parts which have received the start gesture, till the gesture ends.

Icon is an icon format, used for system icons, software icons and so on, its extension is *.icon or *.ico. Commonly seen software or icons on Windows desktop are in the format of ICON. Icon element consists of two sub-element options: small-icon sub-element and large-icon sub-element. A file name is a relative path to the root of a Web application Archive (WAR) file. Deployment descriptors do not use the icon elements. However, if XML tools are used to edit the deployment descriptors, the XML editors can use the icon elements. Icons are a special type of small bitmaps; their maximum size is 32×32 pixels.

In existing schemes, the selection of icons is performed by direct clicking or by one to one correspondence selection. To provide a convenient operation for users, the present invention will provide a small area as an area of search, selection and control to operate the screen. A user can select separated areas in a small area, and after the selection, the screen will rearrange the icons and content in a selected area. The user will re-select the newly separated areas in the small area, and the screen will enter into corresponding areas and arrange the selected objects. Content that needs to be selected will be separated into separate areas. Directly selecting the corresponding contents by selecting back or switch or other operations can be performed. When the device enables the small area selection method, the small area is open. The small area collects user click, drag, and other operation features, and the operation content can be different kinds of recognizable information. After the information is confirmed, the current screen will be again processed by analyzing the operation content. In some cases, the presenting information on the screen can be rearranged, and in other cases, display of some area on the screen can be operated around the small area. Before the operation, the small area needs to be opened, and when the operation mode needs to change, closed and returned to the original operation or shift to a new operation mode.

According to the operations performed by the user on the small area, the method of operating the entire screen comprises: in a small area, select, translate, flip, rotate, and other operations. The entire screen after the operation will according to the operation, rearrange the icons and put the icons on a specific interface. Large screen icons or regions can move, flip, rotate, reset, enable, for example. The small area operated by the user does not have to be a fixed area and maybe of a wide variety of sizes and shapes. The size and location of the small area is unrestricted. After an operation on the small area, the content of the operation can be associated with changes on the interface, or be totally not identical. The operation mode can be set freely. That is, even if two persons use a same operation interface, the operation effects are different. When an operation needs to be cancelled or switched to, the small area may provide confirmation by pressing a key, drawing with a pen or dragging, it can also be switching among different small areas. For any one place on the screen, a person can operate or process it via the small area. The screen can support full-screen translation, rotation and other functions, but also supports a screen portion for translation, rotation, flip, zoom and other functions. For the icons, the screen can perform column operations, line operations, or indefinite operations. The operations of the users on the small area will contain operations of the large screen. The small area can also show a corresponding region, and operate the same as in this area and the large screen.

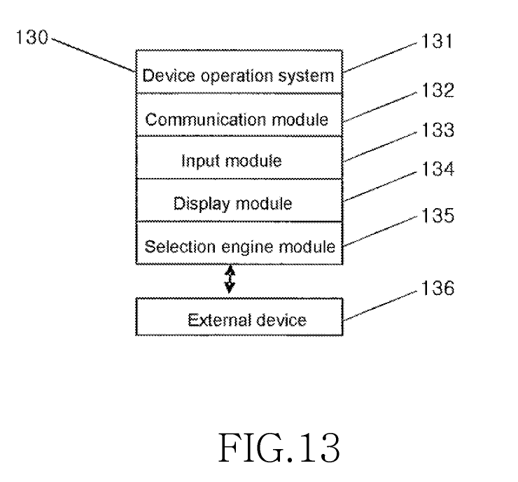

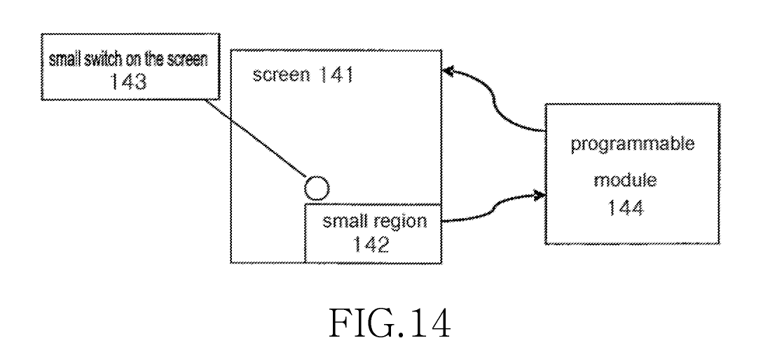

FIGS. 13 and 14 show respective modules of the electronic device related to the screen operating device provided by the present invention. The device 130 includes a device operation system 131, a communication module 132, an input module 133, a display module 134, a selection engine module 135, and an external device 136. The device operation system 131 and the communication module 132 of the device 130 are used for the communication among respective modules inside the system and for mutual connection between inside devices and outside devices. Under certain circumstances, the present invention can use the present device as small module, big screen and the remaining devices as display module to operate. Input module 133 will collect user operation data and send it to a selection engine module 135 to process. The input module 133 is not necessarily a fixed small box; however, it can be with a corresponding larger scope. It is not necessarily rectangular, but can be a sector or with other shapes. The input module is not necessarily two-dimensional but can also be three-dimensional. Information received by this input module 133 will be used to operate on the contents of the existing screen, including respective elements such as links, icons, buttons, text boxes, for example. The operation can also be carried out over the entire screen. The display module will receive selection or operation instructions that are initiated by the operation system 101 and processed by the selection engine module 135. These instructions will make the existing display module 131 change. The change can comprise change of the whole screen, or of a certain area on the screen, or change among these areas. After the display module has made a change, it will wait for another instruction of change or restore. The external device 136 acts as the cell block (small area) of the device 130. Or the device 130 acts as a cell unit while device 136 acts as a large-screen device. The communication module 132 performs communication between the external device 136 and the device 130, and the selection engine module 135 is still treated as a module for processing data of the input module 133. The screen 141 includes: a small area 141 in the screen, a small area switch 143 on the screen, and a programmable module 144. Under normal circumstances, when click the small area switch 143 on the screen, the small region 142 located in the screen 141 will be opened. The operation on the small region 142 will be transmitted into the programmable module 144 of the operation system and after processing the operation, a return value is returned to the screen 141.

In operation,

Start and functions of a small marquee (a marquee as used herein is a scrolling area or window of text):

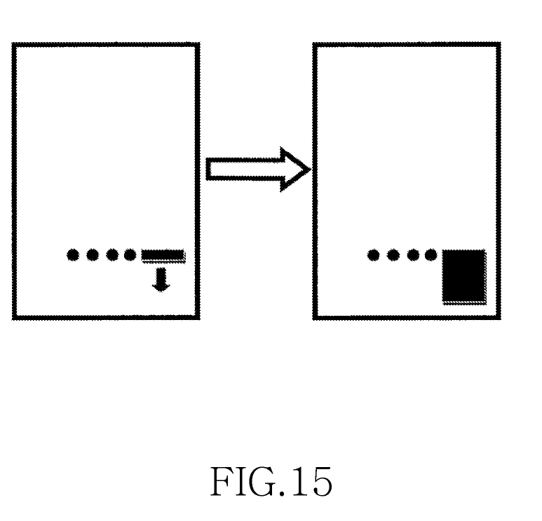

1. A small dialog box for selection can be provided in the following ways (on the basis of without prejudicing an existing interface):

<1> start the small marquee by adding an option in Setting.

<2> start the small marquee mode by adding a drop-down menu after the slider bar, as shown in FIG. 15 in which selection of one element performs an enlargement.

<3> start the small marquee by starting a dynamic translucent small icon, as shown in FIG. 4.

2. The following functions can be set in the small dialog box:

<1> select icon by pressing a key or by sliding.

<2> switch icon screen.

<3> back.

<4> short-cut operation.

3. The location of the small dialog box for selection:

The small box location can be based on command, put into Icon grids of an interface, or be displayed cross-grid. When a floating icon is used, the small box can be opened directly and does not need to take up a grid, that is, the layer-top mode.

4. Method of small marquee generation and location:

(1) If the original interface is not to be affected, a button drop-down small box enables selection of a different interface.

(2) Representation of the active small box can be set on the interface, and the small marquee can be opened.

(3) The small box can be set and located by using settings in configuration Settings.

Concrete realization of several small boxes:

1. Joystick ring method:

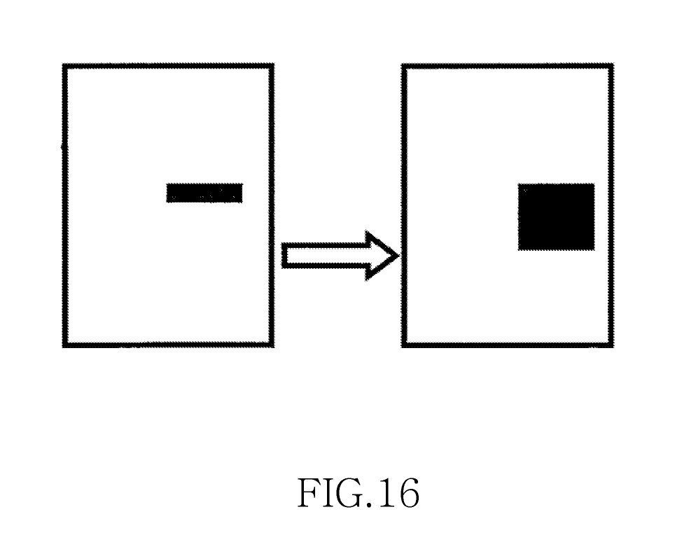

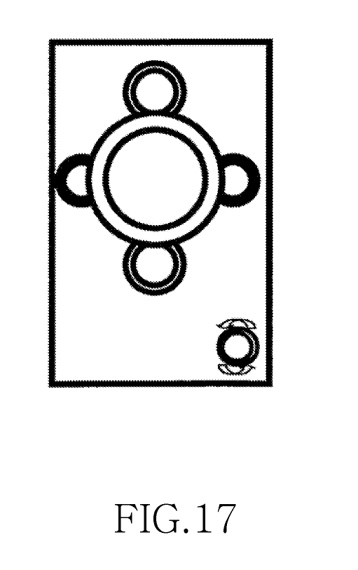

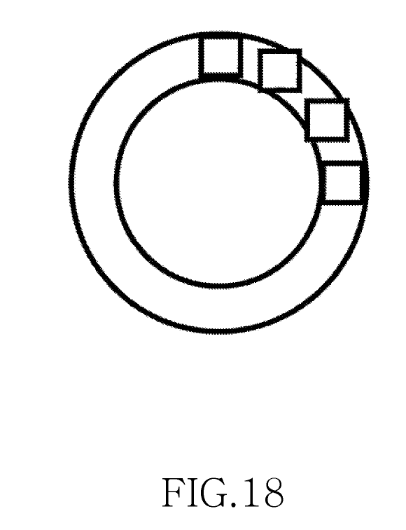

FIG. 16 shows APP ICON enlargement. As shown in FIGS. 17-18, by using a joystick-like setting in a small box, icons can be selected in a ring. The peripheral circle icons are selected. Convenient shortcut functions are selected by joystick. For example: power off, open/close data traffic, turn on/turn off Bluetooth, adjust the volume, for example. Icons correspond to the large circle, and correspond to respective angles of the joystick. While the number of ICONs put in one circle is determined according to the size of the screen. Since the joystick accuracy can be affected by the size of the joystick, the bigger the screen and the higher the screen resolution, the higher the joystick movement accuracy is. A clockwise and counterclockwise circle is defined as the next circle and a further next circle respectively, and a double-click is defined as a confirmation, for example. In FIG. 17, icons are disposed around a ring and spaced apart each other. The icons may be located in a different format. In FIG. 18, icons are disposed between two rings in a periodical pattern. The pattern of icons may be varied according to the number icons.

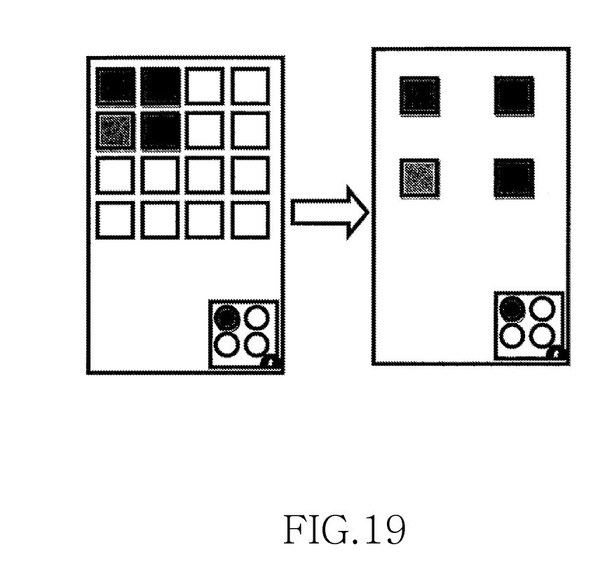

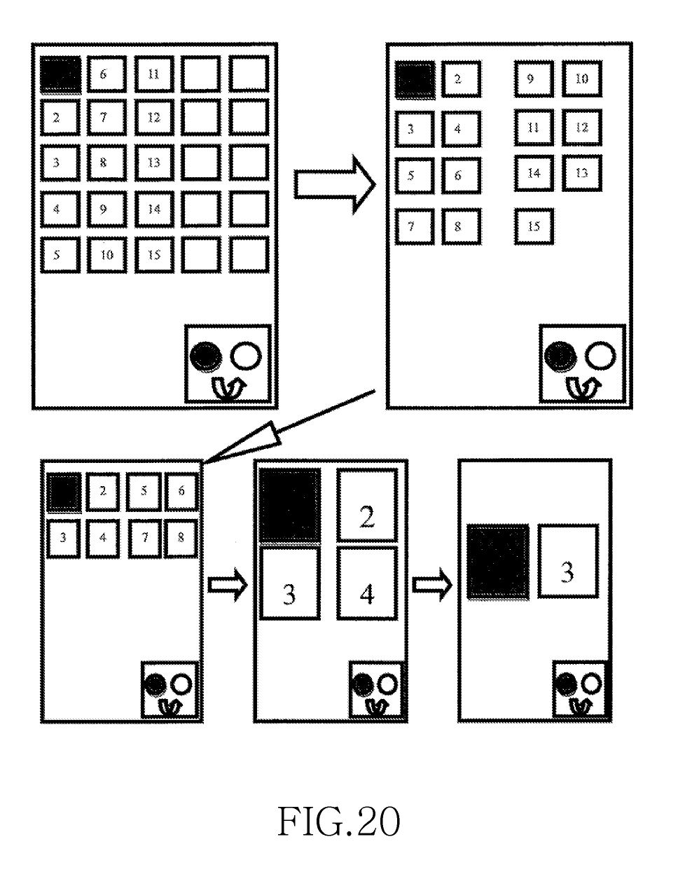

2, square method:

<1> Quick Selection method: after start a small box is selected, the small box is separated into 2 or 4 (quartering) keys plus a back/switch key. Icons on a current phone screen are arranged into even rows and even columns. Also by taking the center of the selected icons as a boundary, the system distinguishes corresponding icon modules, and arranges the selected icons according to the above method. If the number of columns and lines are not n-th power of 2, icons on extra lines will be listed on both sides. The icons are separately arranged in 2 or 4 blocks. In FIG. 19, an icon is selected by using a quartering method. As shown in FIG. 20, the icon is selected by using a dichotomy method (the number of lines and rows are not n-th power of 2). This method can be applied to a small box randomly placed in a location on the mobile phone screen.

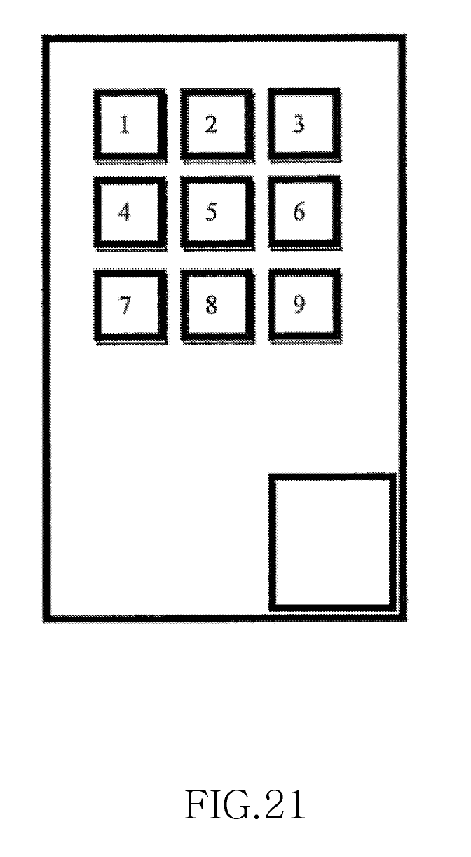

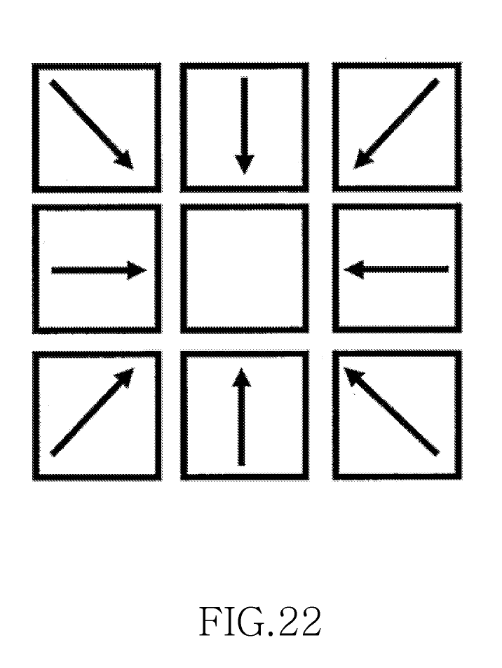

By using the selection button, right and left are selected by using the dichotomy method and by using the quartering method and four areas are selected, for example. After a selection, the selected parts will be rearranged on the screen for another selection. By using the dichotomy method, 2 will be left, and when a quartering method is used and there are no more than 4, a corresponding APP will be selected. The method is equally applicable to a big screen. The selected method can be put into the small marquee, and information of different areas displayed in the small box for view or operation. The flow comprises (dichotomy).

<2> Identification selection method: as shown in FIG. 21, icons are arranged in the blocks of 3×3. As shown in FIG. 22, by writing in the small area of the Input of FIG. 21, an icon is determined. The kind of functions of the small area can be added by setting a writing format as back or switch.

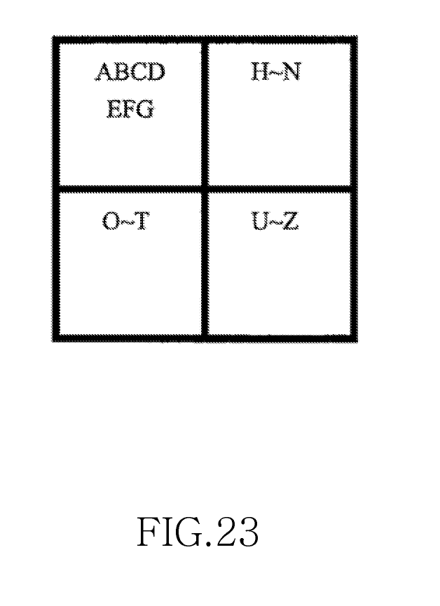

Determine by using the hand writing matching

<3> letter identification method: the method is extended from the rapid selection method. Icon arrangement is not in accordance with the original arrangement, but through the applications of the rearrangement of the initials. The system re-sorts by recognizing the initials of the applications, for example selecting the application “map”. As shown in FIG. 23, the key on the upper left corner is pressed, and the corresponding lower left corner is pressed.

Similar to the rapid selection method, the determination condition becomes the name of an app.

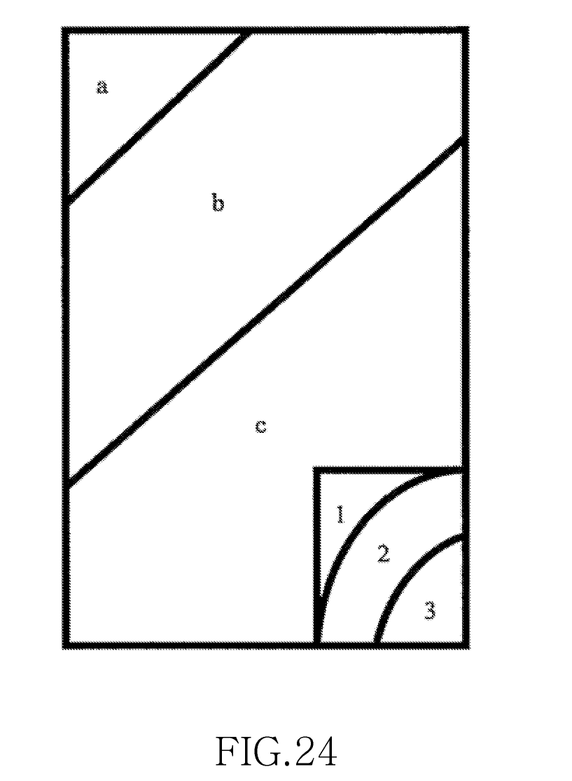

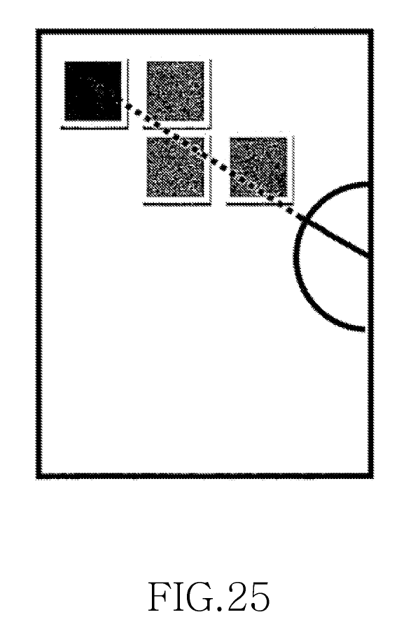

3. Sector method:

<1> Sector area selection key pressing method: after initiating the small area selection mode, a sector select box is shown in FIG. 24. “a” represents “Notification bar” or other information, “b” represents where individual application icons are put, “c” represents where a next set of icons are put, “1” represents a selection button, “2” represents an application key is selected, and “3” represents other buttons. Other functions can be created by combination of buttons 1, 2 and/or 3.

<2> Sector area selection by drag select method: as shown in FIG. 25, 2 grids or one grid on a mobile phone is (are) used to select. Corresponding applications can be selected according to different angles and distances in the small area. For example, when the blue application needs to be selected, the area near the red color needs to select. However, the size and the area location of this sector area can be adapted to different screens.

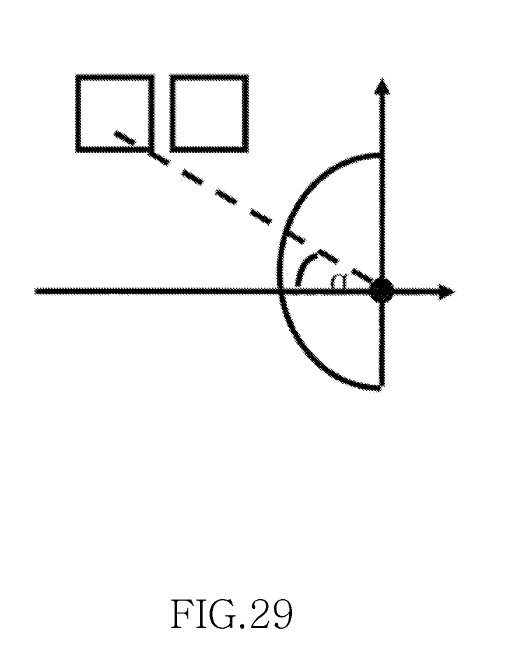

The sector area selection method mainly compares the location in a current small box with the center location of an arc to get a location which is at the location of the radius. Since the sector area on the mobile phone is uncertain, so the distinguishing of a fuzzy area is uncertain. As shown in FIG. 29: angle a determines a selected angle and the dotted line is a selected path. The dotted line sections in the circle are distinguished by the number of applications on the path directed by the dotted line. Different sections will represent different far or near application. When the origin is pressed, an application is entered.

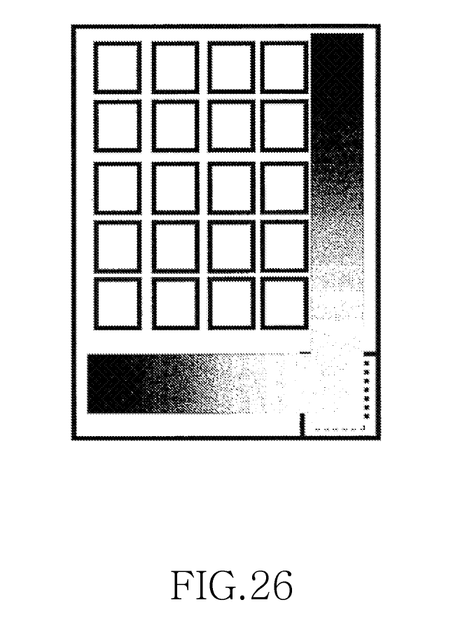

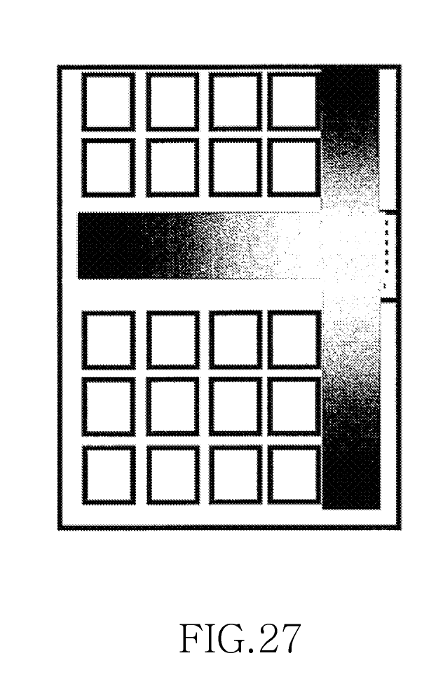

4. Sliding selection method: this method seeks to transform based on the original interface. As shown in FIG. 26, in the small area on the lower right corner, left and right and up and down sliders are set. A needed application is slid to a location in the small area by using the sliders, and is selected. This small area can be put in grids, and can be changed by the user according to his preference, as shown in FIG. 27.

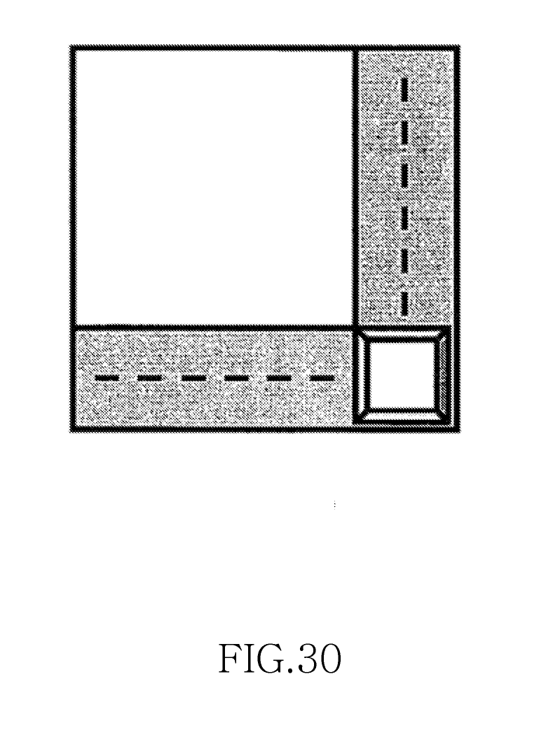

Large screens used for various applications can be used as a small marquee to perform selection operation. Corresponding blocks are generated according to the arrangement of applications on the current screen. A corresponding ICON can be rolled into the small marquee during the sliding. Reference to FIGS. 26 and 27, a small marquee is built on the existing interface. The small marquee can be located at different areas. In the small marquee, functions of selecting application, scroll right and left by column and by page, scroll up and down by line, function switching function are contained, as shown in FIG. 30.

The various screen operation methods and the devices provided by the system are applicable to various mobile terminals. These selection methods are mainly intended to build a relationship between the small marquee and respective areas or blocks on the screen by building a mobile small marquee, so as to rapidly make selections and use a mobile phone or a tablet PC when an electronic device is held by one hand. After the small marquee is created, there are a lot of ways to operate on the screen, and the main purpose of the small marquee is to display a selected area on the screen, while this area can be operated in the small area. To use the APP conveniently, the small marquee is enlarged so as to accommodate more contents. For example, for the quick selection quartering method, when the small marquee is enlarged, though the scope of operation is enlarged, the steps of selecting are reduced, so that a corresponding block can be selected rapidly to achieve the purpose of rapid selection. A user can operate a device such as a mobile phone or a big screen by one finger and a user may define a small area with more free space for convenient operation.

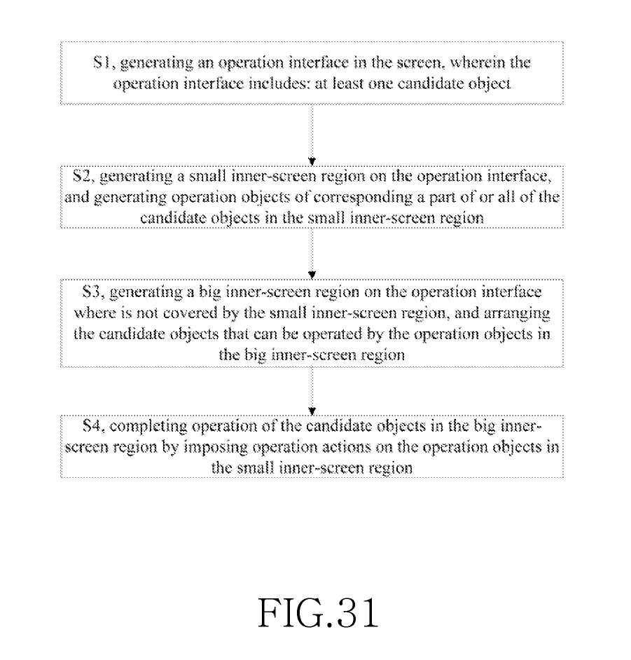

In FIG. 31 a system operates by generating an operation interface in the screen wherein the operation interface contains at least one candidate object; in step S1, generating, on the operation interface contained in a screen, a small inner-screen region where corresponding operation objects of a part of or all of candidate objects are contained; in step S2, generating a small inner screen region on the operation interface, and generating operation objects of corresponding objects in the small inner screen region. In step S3 generating a big inner-screen region in an area on the operation interface which is not covered by the small inner-screen region, and arranging the candidate objects that can be operated by the operation objects in the big inner-screen region, and in step S4, completing operation of candidate objects in the big inner-screen region by imposing operation actions on the operation objects in the small inner-screen region. The candidate objects and the operation objects respectively comprise at least one object of: icon, interval, region, block, content, text, and image and the operation actions comprise at least one action of: selecting, translate flip and rotate. According to another implementation, step S3 comprises: completing an operation of search, select or control for the candidate object in the big inner-screen region by imposing the operation actions on the operation objects in the small inner-screen region.

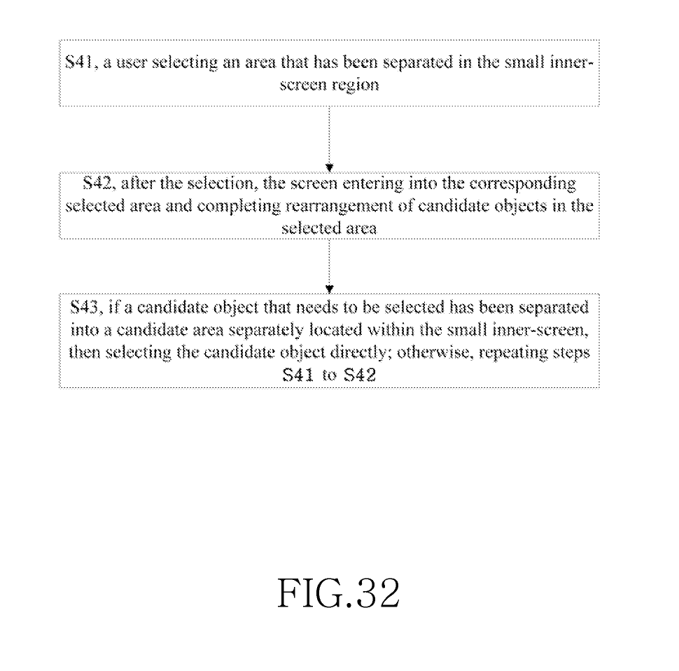

According to another implementation (as shown in FIG. 32), the step S3 further comprises steps S41, S42 and S43. In step S41 a terminal selects an area that has been separated in the small inner-screen region. In step S42, after the selection, the system populates data into the corresponding selected area and completes rearrangement of candidate objects in the selected area. In step S43, if a candidate object that needs to be selected has been populated into a candidate area separately located within the small inner-screen region, the system selects the candidate object directly, otherwise, repeats steps S41 to S42.

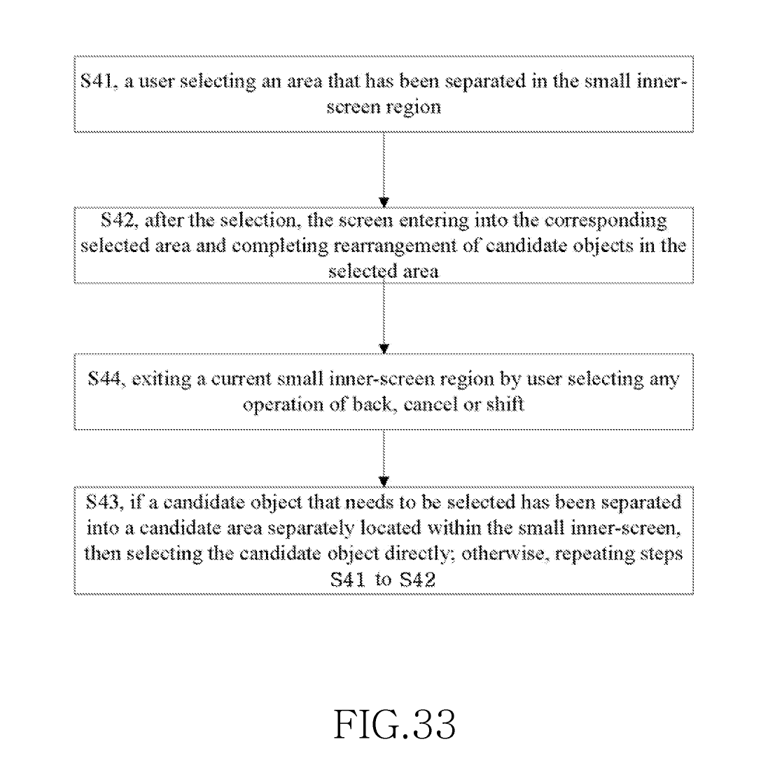

According to another implementation (as shown in FIG. 33), after the step S42 and prior to the step S43 of FIG. 32, step S44 is performed comprising exiting a current small inner-screen region by selecting a back, cancel or shift operation. When the back, cancel or shift operation needs to be chosen, an operation mode of pressing a key, drawing with a pen and a drag operation is configured for use in the small inner-screen region. The system rearranges the candidate objects in the big inner-screen region separately or populates the candidate objects around the small inner-screen region in a circular arrangement. In an embodiment, the step S3 further comprises, when an operation mode needs to change, restoring an original operation or changing to a new operation mode by closing or switching the small inner-screen region. In other embodiments, the small inner-screen region is a fixed area or an unfixed area, the size area of the small inner-screen region is an area of a fixed size or an area with an adaptable size, the location area of the small inner-screen region is a fixed location or a movable location and the candidate objects in the big inner-screen region change in an identical or un-identical way with the operation objects in the small inner-screen region.

In other embodiments, the screen comprises the functions of, supporting translation and rotation of the full screen, supporting a portion to translate, rotate, and zoom, column operation, row operation or indefinite operation on icons and the operation on the candidate objects is performed by alternatively using the small inner-screen region and the big inner-screen region.

The system provides a screen operation device, comprising a display module, configured to display an operation interface, wherein the operation interface contains at least one candidate object; an input module, configured to collect operation information and generate operation data. A first module is configured to make a small inner-screen region contained in the operation interface and make operation objects corresponding to a part of or all of candidate objects contained in the small inner-screen region; and a second module is configured to make a big inner-screen region contained in an area of the operation interface not covered by the small inner-screen region. The candidate objects that can be operated by the operation objects are arranged in the big inner-screen region; a selection engine module is configured to process operation data sent by the input module so as to complete operation of the candidate objects in the big inner-screen region by imposing operation actions on the operation objects in the small inner-screen region.

The system provides a screen operation device, comprising a display module, configured to display an operation interface, wherein the operation interface contains at least one candidate object, an input module, configured to collect operation information and generate operation data. The input module comprises a first module configured to provide a small inner-screen region contained in the operation interface and make operation objects corresponding to a part of or all of candidate objects contained in the small inner-screen region and a second module configured to make a big inner-screen region contained in an area of the operation interface that is not covered by the small inner-screen region, and arrange the candidate objects that can be operated by the operation objects in the big inner-screen region. A selection engine module is configured to process operation data sent by the input module so as to complete operation of the candidate objects in the big inner-screen region by imposing operation actions on the operation objects in the small inner-screen region.

In other embodiments, the candidate objects and the operation objects respectively comprise at least one object of: icon, interval, region, block, content, text, and image, the operation actions comprise at least one action of: select, translate, flip, and rotate, the selection engine module is configured to perform an operation of searching, selecting or controlling of the candidate objects on the operation screen. In another embodiment, the display module is configured to, display regions that have been separated in the small inner-screen region for selection, after the selection, the screen provides a corresponding selected area and completes rearrangement of candidate objects in the selected area and if a candidate object that needs to be selected has to be populated into a separate candidate area in the small inner-screen region, the candidate object is selected directly. In another embodiment, the display module is configured to display items for exiting a current small inner-screen region by selecting a back, cancel or a switch operation. When a back, cancel or switching operation needs to be selected, the small inner-screen region is configured with an operation mode of pressing a key, drawing with a pen, and drag. Further, the system rearranges the candidate objects in the big inner-screen region separately or populates the candidate objects around the small inner-screen region in a circular arrangement.

The display module, when an operation mode needs to change, restores an original operation or changes to a new operation mode by closing or switching the small inner-screen region.

In different embodiments, the selection engine module is configured to complete the operation of the candidate objects by alternatively using the small inner-screen region and the big inner-screen region, the input module is of different shape including one of, rectangle, triangle, circle or sector and is a two-dimensional input module or a three-dimensional input module. The screen operation device also includes a device operation system, a communication module and an external module used as the first module. In different embodiments, the step of initiating the small inner-screen region includes adding an option to the settings, adding a drop-down menu after a slider bar and initiating a small dynamic translucent icon.

Operations in the small inner-screen region include, selecting an icon, which again comprises selecting by pressing a key or selecting by sliding, switching icon screens back and shortcut operation. Further, the location of the small inner-screen region is put into an Icon grid of an operation interface, or a displayed cross-grid. When the candidate objects in the operation interface are floating objects, the small inner-screen region can be opened directly.

The small inner-screen region is configured to select the operation objects using a joystick ring by arranging the operation objects round the circular joystick or arranging the operation objects around the joystick. The small inner-screen region is configured to select the operation objects using the joystick ring at power-off, open/close of data flow, open/close of Bluetooth, and adjustment of voice volume, for example.

The small inner-screen region is configured to select the operation objects using icons at respective angles of a joystick ring and determining the number of Icons placed in the joystick ring according to the size of the screen.

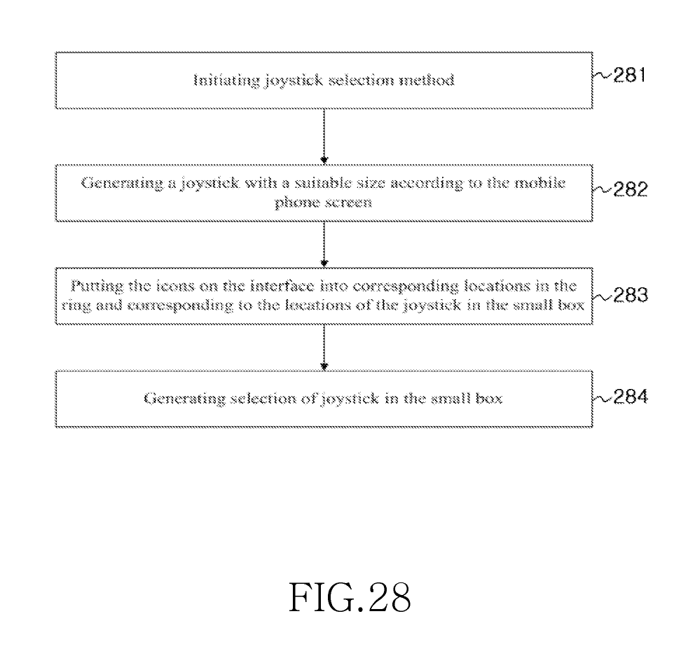

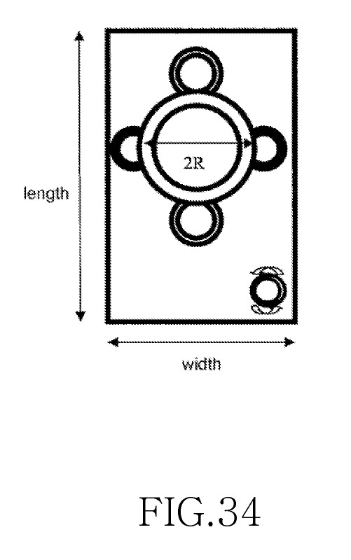

According to another implementation (as shown in FIG. 28), the small inner-screen region is configured to select the operation objects using a joystick by in step 281 initiating a joystick selection method. In step 282, the system generates a joystick with a suitable size according to the size of the screen. The system in step 283 puts the operation objects on the operation interface into corresponding locations inside the joystick ring, and corresponding to the location of the joystick within the small inner-screen region. in step 284 the system generates small box joystick selection. As shown in FIG. 34, if the length of the mobile device screen is Length and the width thereof is Width, then the radius of the joystick ring is radius R, R being smaller than ½ of whichever smaller in the width and length. While the candidate joystick ring radius r around the big joystick ring is r<(min[Length,Width]−2R)/4.

According to another implementation, the small inner-screen region is configured to select the operation objects in a key area by, after the small inner-screen region is initiated, generating 2n or 4n keys and a back/switch key as the operation objects in the small inner-screen region; generating a block area by taking the center of the candidate objects on a current screen as a boundary, and arranging the candidate objects into even rows and even columns; and if the number of the rows or columns are not n-th power of 2, then arranging the extra candidate objects outside of the block area separately.

The system provides a screen operation method, comprising the following steps: generating a small inner-screen region on an operation interface in a screen containing candidate objects, and the small inner-screen region containing corresponding operation objects of a part of or all of candidate objects, wherein the small inner-screen region is configured to select the operation objects by a drawing with pen; containing a big inner-screen region which corresponds to the small inner-screen region on the operation interface where is not covered by the small inner-screen region, and arranging the candidate objects that can be operated by the operation objects in the big inner-screen region, and completing operation of the candidate objects in the big inner-screen region by imposing operation actions on the operation objects in the small inner-screen region.

The small inner-screen region is configured to select the operation objects by drawing with a pen comprises: after the small inner-screen region is initiated, generating an area with 3×3 blocks by take the center of the candidate objects on the screen as a boundary, and corresponding the candidate objects in the area with 3×3 blocks to 9 keys pointing to different directions generated in the small inner-screen region.

The small inner-screen region is configured to select the operation objects by an initial letter after the small inner-screen region is initiated, generating different keys according to English initials in the small inner-screen region; and corresponding the initials of the candidate objects on the current screen with the keys separated according to their initials in the small inner-screen region respectively.

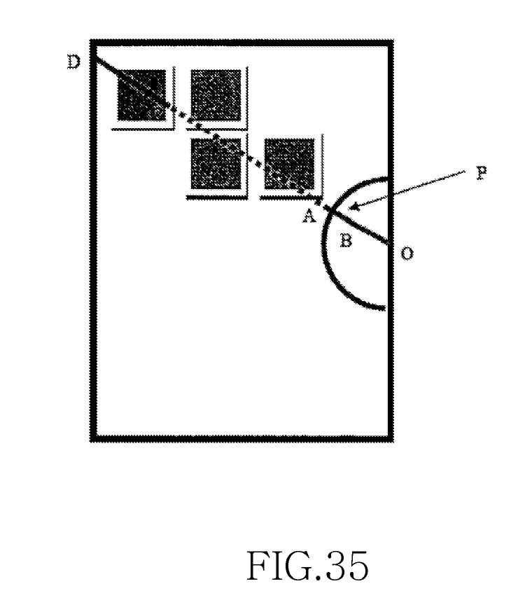

The small inner-screen region is configured to select the objects by a sector region comprising after the small inner-screen region is initiated, generating a first sector, a second sector, and a third sector by the sector region in the small inner-screen region; generating sector a, sector b, and sector c by the sector region in the large inner-screen region, wherein candidate icons on a current operation interface are put into sector b, candidate icons on a next layer of operation interface are put into sector c, other information except for those in sector b and sector c is stored in sector a; and selecting corresponding candidate objects according to different of angles and different distances in the small inner-screen region. As shown in FIG. 35, it is assumed that the point P is in the sector with O being its radius, and P is located on the radius OA. Since on the radius OA, the line AB corresponds to the application of CD at the extension of AD, so point P corresponds to the application corresponding to the end CD. Since the sector location can be variable, e.g. it may be located at the bottom right corner of 90-degree sector area, so it is necessary to rely on the angle between the horizontal radius of the center (O) and the actual point of contact OP to determine a certain line on the extension line of the application of the corresponding radius OA segment. The size and regional area of the sector region are adjusted according to the candidate objects. The system selects corresponding candidate objects according to different of angles and different distances in the small inner-screen region by comparing a location of a candidate object in the small-inner screen region with the center location of the sector arc, getting a location of the candidate corresponding to the radius of the arc.

It can be understood by those skilled the art that certain parts of the above specific implementations can be demonstrated by algorithms, programs, or software modules, and these demonstrations comprise operations on the data stored in the computer memory. These demonstrations basically consist of instruction sequences of the operation which carries out the effects. These operations require or relate to physical operations and controls or physical variants. Usually, but not necessarily, these variants are in the form of electrical or magnetic signals, and these signals can be stored, transmitted, merged, compared or operated & controlled in other ways. It can be understood by those skilled in the art that, sometimes (mainly for purpose of general use) these signals are referred to as expressions of bit, value, element, symbol, character, item, number etc. But it is to be understood, these and similar terminologies are associated with suitable physical variants, and are only used for convenience of labeling these variants. Description by using the terminologies such as “process”, “determine”, “calculate” or “display” in the whole specification may refer to actions and processes carried out by data processing system or similar electronic devices, and the actions and processing operate data represented by physical (e.g. electronic) variants in the registers and storage, and transform it into other data represented in the form of physical variants stored, transmitted, displayed in the storage, register, or other similar device.

It can be understood by those skilled in the art that the invention can be implemented as methods, circuits or communication systems. Therefore, the invention can be in the form of hardware implementation, overall software implementation or implementation combining software and hardware, all these forms being referred to as “circuit”. The steps of the methods or algorithms described in combination of embodiments disclosed herein can be implemented by hardware directly, software modules executed by a processor or their combination. The software module can be placed in RAM, memory, ROM, EPROM, EERPROM, registers, hard disk, removable disk, CD-ROM, or any other kinds of storage media well known in the art.

It can be understood by those skilled in the art that implementing the above all or part of the steps carried in the implementations and methods can be completed by using a program to instruct related hardware, and the program can be stored in a kind of computer storage medium. When the program is executed, one of or combination of steps of the implementations are included. In addition, the individual functional units in respective implementations can be integrated into a processing module, or the individual units exist physically separated, or two or more units are integrated into one module. The above integrated module can be implemented by way of hardware or can be implemented by way of software. If the integrated module is implemented by way of software and sold or used as an independent product, it can be stored in a computer readable storage medium. The storage medium can be ROM, magnet disk or disk, etc.

It can be understood by those skilled in the art that the implementations of the present invention may be a part of other types of data processing systems, these data processing systems for example are an entertainment system or a personal data assistor (PDA), a general purpose computer system, a specialized computer system, an embedded device embedded in another device, a mobile phone that does not contain a media player, a multi-touch controlling tablet device, or other multi-touch controlling devices or a device combining various aspects and functions of these devices.

It can be understood by those skilled in the art that object-oriented programming languages such as the Java®, Smalltalk, or C++, conventional procedural programming languages such as “C” programming language, or low-level codes such as the assembly language and/or micro-code can be used to write computer program codes used to execute the operations of the present invention. The program codes can executed on a single processor as an independent software package and/or be executed on multiple processors as a part of another software package.

It can be understood by those skilled in the art that the present invention have been described with reference to the structural diagrams and/or blocks and/or flowcharts of methods, systems, and computer programming products of the implementation of the present invention. It should be understood that each block in the structural diagrams and/or blocks and/or flowcharts or blocks combinations in these structural diagrams and/or blocks and/or flowcharts or blocks can be implemented by using computer programming instructions. These computer programming instructions can be provided to a general purpose computer, a specialized computer or other processors of programmable data processing methods to generate the machine, so that the instructions executed by a computer or processors of other programmable data processing methods to create the methods indicated by the boxes in the structural diagrams and/or block diagrams and/or flowcharts.

It can be understood by those skilled in the art that these computer instructors can also be stored in a computer-readable memory, the computer readable memory may guides a computer or other programmable data processing methods run in a particular manner, so that the instructions stored in a computer readable memory can generate such products, and the products include the instruction methods indicated by the boxes in the structural diagrams and/or block diagrams and/or flowcharts.

It can be understood by those skilled in the art that these computer programming instructions may also be loaded into a computer or other programmable data processing methods to make a sequence of operation steps can be executed on the computer or other programmable data processing methods to generate processes that can be implemented by the computer; thus the instructions executed on the computer or other programmable data processing methods provide steps for implementing steps indicated in the box or boxes in the structural diagrams and/or block diagrams and/or flowcharts.

It can be understood by those skilled in the art that the steps, measures, schemes in the various operations, methods and flowcharts that have been discussed can be alternated, changed, combined or deleted. Furthermore, other steps, measures, schemes having the various operations, methods and flowcharts that have been discussed can also be alternated, changed, rearranged, decomposed, combined or deleted. Furthermore, the steps, measures, and schemes in the traditional art or in the present invention can be alternated, changed, rearranged, decomposed, combined or deleted.

The exemplary implementations are disclosed in the accompanying drawings and the specification. Though certain terminologies are used herein for general and description usage purpose, and should not be constructed as limiting. It should be pointed out that for those ordinary skilled in the art, various modifications and improvements can be made without departing from the principle of the invention, and those modifications and improvements should be deemed as in the scope of the present invention. The protecting scope of the present invention should be defined by the claims of the present invention.

The foregoing is part of embodiments of the present invention. It should be pointed out that a person having ordinary skill in the art may also make several improvements and modifications in the premise of not losing the principle of the present invention, and these improvements and modifications should also be regarded as the protection scopes of the present invention.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

What is claimed is:

1. A method for operating a screen in an electronic device, the method comprising:
detecting a touch in a predetermined region of a destination page comprising a window area of reduced size within the destination page;
mapping the detected touch to a corresponding region of the destination page external to the predetermined region; and
selecting an icon of an application on the corresponding region in response to the detected touch.

2. The method according to claim 1, further comprising:
switching the destination page upon detecting that the predetermined region is touched in excess of a predetermined time, or clicking a button for switching the destination page on the predetermined region;
determining that the current page is the destination page when it is detected that a long duration touch is terminated or clicking the button for switching the destination page is stopped.

3. The method according to claim 1, wherein the predetermined region includes one or more areas of a blank area of the screen and a floating window suspended on the screen.

4. The method according to claim 1, wherein the predetermined region has a mapping in one-to-one correspondence with the screen areas where applications are on the destination page, or a mapping in one-to-one correspondence with the screen areas where parts of the applications are on the destination page.

5. The method according to claim 4, wherein the mapping of the predetermined region is transparent to a user or is displayed on the predetermined region, and
wherein the mapping displayed on the predetermined region comprises mapping the icon of the application on the screen area displayed on the corresponding position of the predetermined region.

6. The method according to claim 1, further comprising
executing the selected application when the icon of the application on the corresponding area is selected and the touching action is stopped on the predetermined region.

7. An electronic device, comprising:
a detection module configured to detect a touching operation in a predetermined region of a destination page comprising a window area of reduced size within the destination page;
a mapping module configured to,
map the detected touching operation to a corresponding region of the destination page external to the predetermined region, and
select an icon of an application on the corresponding region in response to the detected touch.

8. The device according to claim 7, wherein the mapping module is used to map screen areas presenting icons associated with applications on the destination page in one-to-one correspondence with the predetermined region, or map screen areas associated with portions of the applications on the destination page in one-to-one correspondence with the predetermined region.

9. The device according to claim 8, wherein the mapping of the predetermined region is transparent to a user or is displayed on the predetermined region.

10. The device according to claim 6, further comprising an execution module for running a selected application when the detection module detects that the icon of the selected application on the corresponding area is selected and the touching action on the predetermined area is stopped.

11. A method in an electronic device, the method comprising:
generating, on an operation interface screen including a small inner-screen region where corresponding candidate objects are presented;
providing a big inner-screen region in an area on the operation interface not covered by the small inner-screen region, and arranging the candidate objects that can be operated by the operation objects in the big inner-screen region, and
configuring operation of the candidate objects in the big inner-screen region by assigning operation actions on the operation objects in the small inner-screen region.

12. The method according to claim 11,
wherein the candidate objects and the operation objects respectively comprise at least one object of, icon, interval, region, block, content, text, and image,
wherein the operation actions comprise at least one action of, selection, translation, flip and rotation.

13. The method according to claim 11, comprising completing an operation of searching, selecting or controlling a candidate object in the big inner-screen region by imposing the operation actions on the operation objects in the small inner-screen region.

14. The method according to claim 11, comprising
(a) selecting an area that has been separated in the small inner-screen region;
(b) after the selection, the screen entering into the corresponding selected area and completing rearrangement of the candidate objects in the selected area;
if a candidate object that needs to be selected has been separated into a candidate area separately located within the small inner-screen region, selecting the candidate object directly; otherwise, repeating steps (a) and (b).

15. The method according to claim 14, further comprising:
exiting a current small inner-screen region by selecting a back, cancel or shift operation.

16. The method according to claim 15, wherein the back, cancel or shift operation is chosen by an operation mode of a key press, drawing with a pen and dragging to the small inner-screen region.

17. The method according to claim 14, wherein the rearrangement comprises:
rearranging the candidate objects in the big inner-screen region separately; or
placing the candidate objects around the small inner-screen region as a circular arrangement.

18. The method according to claim 14, further comprising:
when an operation mode needs to change, restoring an original operation or changing to a new operation mode by closing or switching the small inner-screen region.

19. The method according to claim 11,
wherein the small inner-screen region is a fixed area or an unfixed area,
wherein the size of the small inner-screen region is a fixed value or an adjustable value,
wherein the location of the small inner-screen region is fixed or movable,
wherein the candidate objects in the big inner-screen region are changed in an identical or un-identical way with the operation objects in the small inner-screen region,
wherein the screen comprises any of the following functions, supporting translation and rotation of the full screen, supporting translation, rotation and zooming of a portion of the screen,
wherein the screen supports column operation, row operation or indefinite operation on icons, and
wherein the operation of the candidate objects is performed by alternatively using the small inner-screen region and the big inner-screen region.

20. An electronic device, comprising:
a display module, configured to display an operation interface, wherein the operation interface contains at least one candidate object;
an input module, configured to collect operation information and generate operation data, which comprises:
a first module configured to make a small inner-screen region contained in the operation interface and make operation objects corresponding to candidate objects presented in the small inner-screen region; and
a second module configured to provide a big inner-screen region in an area of the operation interface external to the small inner-screen region, and arrange the candidate objects that can be operated by the operation objects in the big inner-screen region; and
a selection engine module configured to process operation data sent by the input module so as to complete operation of the candidate objects in the big inner-screen region by imposing operation actions on the operation objects in the small inner-screen region.
